(19) United States
(12) Patent Application Publication
(10) Pub. No.: US 2015/0370587 A1
(43) Pub. Date: Dec. 24, 2015

(54) COMPUTER-READABLE RECORDING MEDIUM HAVING STORED THEREIN OUTPUTTING PROGRAM, OUTPUT APPARATUS AND OUTPUTTING METHOD

(71) Applicant: FUJITSU LIMITED, Kawasaki-shi (JP)

(72) Inventors: Akira Kureha, Yokohama (JP); Hiroki Sumida, Mishima (JP); Yasuo Yoshimoto, Numazu (JP); Ichiro Yamada, Yokohama (JP); Yoshiko YAMASAKI, Yokohama (JP)

(21) Appl. No.: 14/730,353

(22) Filed: Jun. 4, 2015

(30) Foreign Application Priority Data
Jun. 20, 2014 (JP) 2014-126971

(51) Int. Cl. G06F 9/455

(52) U.S. Cl. CPC G06F 9/45533

(57) ABSTRACT

A computer is caused to execute a process including acquiring operating information relating to an operation situation within a predetermined period of a virtual machine operating on an information processing apparatus from a management machine that performs acquisition of the operating information and activation control of the virtual machine, and outputting, where a first period within which operating information of the virtual machine is not acquired is included in the predetermined period, operation actual results of the virtual machine within the first period based on operating information of the management machine within the first period and operating information of the virtual machine acquired at least at one of preceding and succeeding timings to the first period.

### CROSS-REFERENCE TO RELATED APPLICATION

This application is based upon and claims the benefit of priority of the prior Japanese Patent Application No. 2014-126971, filed on Jun. 20, 2014, the entire contents of which are incorporated herein by reference.

### FIELD

The technology disclosed herein relates to a computer-readable recording medium having stored therein an outputting program, an output apparatus and an outputting method.

### BACKGROUND

A cloud system is known wherein a plurality of virtual machines (VMs) are set in a virtualization environment using a resource of an information processing apparatus such as a server or a PC (Personal Computer) and are provided to users.

Further, in a cloud system, a technology is known wherein, in order to support operation management of a virtual machine (VM) to be provided to users, operating information of a virtual machine (VM) operating on the information processing apparatus is monitored and a result of the monitoring is outputted (refer to, for example, Patent Document 1).

[Patent Document 1] Japanese Laid-Open Patent Publication No. 2010-277208

In a cloud system, an information processing apparatus that is a resource is frequently shared by a plurality of virtual machines (VMs). Therefore, a virtual machine (VM) that is in an activated (started up) state although it is not utilized for execution of processing (such a virtual machine (VM) is hereinafter referred to also as idle-state virtual machine (VM) or idle virtual machine (VM)) wastefully utilizes a resource of the information processing apparatus.

In order to suppress wasteful utilization of a resource by an idle-state virtual machine (VM), for example, it seems recommendable for a manager of the cloud system to urge a user of a virtual machine (VM) to stop an idle-state virtual machine (VM) using a result of monitoring of operating information (usage rate, use amount and so forth of a resource) of the virtual machine (VM).

Normally, the manager can acquire a result of monitoring of operating information of a virtual machine (VM) when the virtual machine (VM) is operating. However, also there is a case in which operating information (performance information) of a virtual machine (VM) to be provided does not exist (is not acquired) in a result of monitoring. Where operating information of at least part of virtual machines (VMs) is not included in a result of monitoring, a plurality of causes are considered applicable that the virtual machine (VM) is in a stopping state, that a machine that performs monitoring (for example, a management virtual machine (VM) that performs management of virtual machines (VMs)) is in a stopping state or fails to operate due to occurrence of a failure and so forth.

Therefore, even if a result of monitoring (operation result) of operating information is provided, it is difficult for the user of a virtual machine (VM) to specify an actual operation situation of the virtual machine (VM) within a period within which there exists no operating information including information of whether or not the virtual machine (VM) has been operative.

In this manner, there is a subject that, since the reliability of a result of monitoring is low, it is difficult for the manager to let the user to be conscious of the necessity for stopping of the virtual machine (VM) and there is a case in which it is difficult to implement suppression of useless utilization of a resource by a virtual machine (VM) in an idle state.

### SUMMARY

According to an aspect of the embodiments, there is provided a computer-readable recording medium having stored therein an outputting program for causing a computer to execute a process. The process includes acquiring operating information relating to an operation situation within a predetermined period of a virtual machine operating on an information processing apparatus from a management machine that performs acquisition of the operating information and activation control of the virtual machine. The process further includes outputting, where a first period within which operating information of the virtual machine is not acquired is included in the predetermined period, operation actual results of the virtual machine within the first period based on operating information of the management machine within the first period and operating information of the virtual machine acquired at least at one of preceding and succeeding timings to the first period.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram depicting an example of an operation situation of virtual machines (VMs) in a cloud system;

FIGS. 2 to 4 are diagrams depicting approximate lines of operating information of virtual machines (VMs) used for data complementation of operation data;

FIG. 5 is a diagram depicting an example of a result of decision of an operation state for every one hour of virtual machines (VMs);

FIG. 6 is a block diagram depicting an example of a configuration of a system according to an embodiment;

FIG. 7 is a view depicting an example of operation data depicted in FIG. 6;

FIG. 8 is a view depicting an example of an operation data list depicted in FIG. 6;

FIG. 9 is a view depicting an example of an operation decision list depicted in FIG. 6;

FIG. 10 is a view depicting an example of a first integration list depicted in FIG. 6;

FIG. 11 is a view depicting an example of a second integration list depicted in FIG. 6;

FIG. 12 is a view depicting an example of virtual machine (VM) management information depicted in FIG. 6;

FIG. 13 is a view depicting an example of an operation actual results report depicted in FIG. 6;

FIG. 14 is a view depicting an example of display of a providing site of the operation actual results report;

FIG. 15 is a view depicting an example of details of the operation actual results report;

FIG. 16 is a view depicting details of an example of contrast of the operation actual results report;

FIG. 17 is a flow chart illustrating an example of a general process of an outputting server according to the embodiment;

FIG. 18 is a flow chart illustrating an example of a production process of an operation data list according to the embodiment;

FIG. 19 is a flow chart illustrating an example of a production process of an operation decision list according to the embodiment;

FIG. 20 is a flow chart illustrating an example of an integration process in a unit of one hour according to the embodiment;

FIG. 21 is a flow chart illustrating an example of an idle decision process according to the embodiment;

FIG. 22 is a flow chart illustrating an example of an integration process in a unit of one day according to the embodiment;

FIGS. 23 to 25 are diagrams depicting approximate lines of operating information of virtual machines (VMs) relating to the embodiment;

FIG. 26 is a view depicting a result of decision of an operation state for everyone hour of virtual machines (VMs) according to a different example;

FIG. 27 is a block diagram depicting a configuration of a system according to a first modification;

FIG. 28 is a view depicting an operation decision list after a data complementation process according to the first modification;

FIG. 29 is a view depicting an example of a first integration list depicted in FIG. 27;

FIG. 30 is a flow chart illustrating a general process of an outputting server according to the first modification;

FIG. 31 is a flow chart illustrating a complementation process of an operation decision list according to the first modification;

FIG. 32 is a flow chart illustrating an integration process in a unit of one hour according to the first modification;

FIG. 33 is a view depicting an operation data list after a data complementation process according to a second modification;

FIG. 34 is a view depicting a first integration list according to the second modification;

FIG. 35 is a flow chart illustrating an integration process in a unit of one hour according to the second modification; and

FIG. 36 is a block diagram depicting an example of a hardware configuration of an outputting server depicted in FIG. 6 or 27.

### DESCRIPTION OF EMBODIMENT

In the following, an embodiment of the present technology is described with reference to the drawings. It is to be noted that the embodiment described below is illustrative to the end, and there is no intention to eliminate various modifications and applications of the technology not specified in the embodiment described below. Therefore, variations and modifications can be made without departing from the scope of the present invention. It is to be noted that, in the drawings used for embodiments described below, unless otherwise specified, like elements to those in the figures are denoted by like reference characters.

[1] Collection of Operating Information

In a cloud system, when virtual machines (VMs) are disposed, a central processing unit (CPU) resource is shared by the virtual machines (VMs). However, a storage region allocated to a virtual machine (VM) is occupied as a memory resource by the virtual machine (VM). Accordingly, in the cloud system, a resource management of an information processing apparatus, particularly of a memory resource, is important.

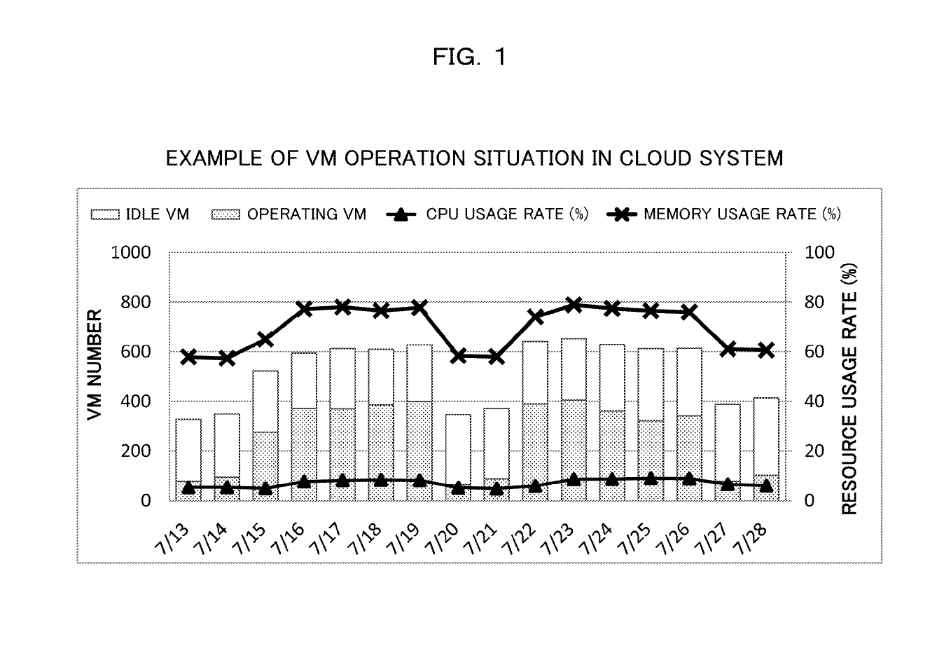

FIG. 1 is a view depicting an example of an operation situation of virtual machines (VMs) in a cloud system, namely, a utilization (operation) situation of virtual machines (VMs) by a user. In the cloud system, a virtual machine (VM) left without performing any process while occupying a memory (an idle-state virtual machine (VM)) can exist. In the example depicted in FIG. 1, it is recognized that approximately thirty percent of virtual machines (VMs) are normally left in an idle state. In FIG. 1, while the memory usage rate is approximately 80% in some days, approximately thirty percent of the used memories are allocated to virtual machines (VMs) left as idle-state virtual machines (VMs).

As described above, in order to release a memory of the idle-state virtual machines (VMs), the idle-state virtual machines (VMs) may be stopped. However, since a manager who does not understand a use application of each virtual machine (VM) is difficult to stop the virtual machines (VMs) without permission, it seems recommendable to urge a user of a virtual machine (VM) to stop the virtual machine (VM). However, a user of a private cloud system provided in an organization such as an enterprise is low in consciousness relating to waste of an allocation resource or energy consumption or an accounting in use of a virtual machine (VM), and frequently leaves a virtual machine (VM) in a normally activated state.

The user can start up a virtual machine (VM) when the user wants to use the virtual machine (VM) and can stop the virtual machine (VM) freely within a period within which the virtual machine (VM) is not to be used. Accordingly, in order to urge the user to voluntarily stop an idle-state virtual machine (VM) to reduce the resource use amount, it is preferable for the cloud system to visualize an operation situation of virtual machines (VMs) relating not only to time zones in which the virtual machines (VMs) operate but also to stopping time zones in which the virtual machines (VMs) stop. This is because, by causing the user to grasp stopping time zones of the virtual machines (VMs), the cloud system can cause the user to correctly recognize an operation situation (utilization situation) of each virtual machine (VM) and have awareness to use the virtual machines (VMs) effectively.

Conventionally, since it is a prerequisite that a server is operating usually, when it is intended to cause the user to recognize an operation situation of virtual machine (VM), it is a principal method to present information of time zones within which virtual machines (VMs) operate to the user. For example, regarding a time zone within which a virtual machine (VM) operates, the cloud system can decide whether the virtual machine (VM) executes processing or is in an idle state from operating information and so forth collected from the virtual machine (VM) and display a result of the decision on a Web site or the like that can be browsed by the user. It is to be noted that a server that acquires operating information indicative of an operation situation of a virtual machine (VM) from a management virtual machine (VM) that collects operating information and performs processing, totalization and so forth and then outputs a result of the process to the user is hereinafter referred to as outputting server.

On the other hand, when a virtual machine (VM) is placed into a power OFF state by the user or operating information is not sampled because of a failure of a management virtual machine (VM) by a system trouble or the like, loss of data occurs. Even if loss of data in operating information occurs in this manner, it is important for the outputting server to decide and complement data in which loss occurs from a point of view of reduction of the resource usage.

However, it is difficult for the management virtual machine (VM) to re-sample operating information sampled once or perform retroactive sampling in the past, and, when loss of data occurs in the operating information, it is difficult to perform totalization again.

To the user, it is difficult to confirm an operation situation of a virtual machine (VM) in the past from information other than operating information presented by the operation entity side (manager). Accordingly, when there is a period within which operating information is lost by a failure of the management virtual machine (VM), it is preferable for the manager to present a report of operating information including information for assisting decision of a loss period of operating information to the user.

[2] Contrast Example

Next, a contrast example to the embodiment is described. It seems recommendable for an outputting server to perform, as a decision method of data lost in operating information, data complementation for the data loss portion caused by a failure of a management virtual machine (VM) using various approximation methods such as a least squares method. However, if the outputting server performs data complementation regarding a time zone within which there is no data in operating information as a time zone of data loss, then a situation different from an actual situation is sometimes represented.

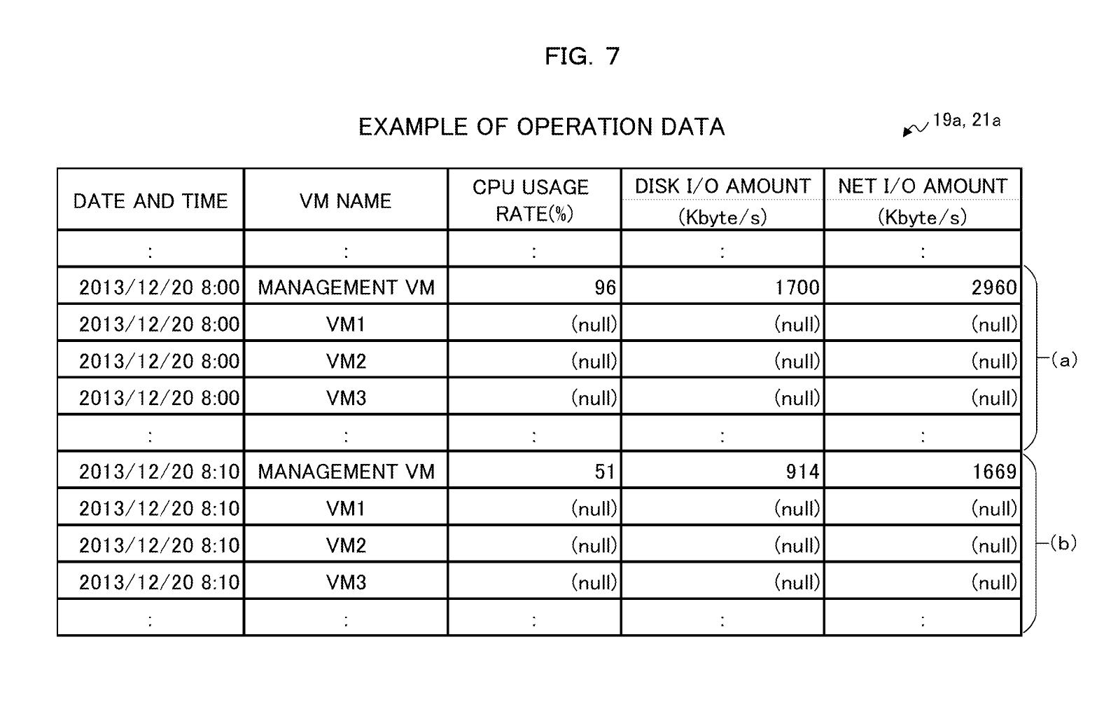

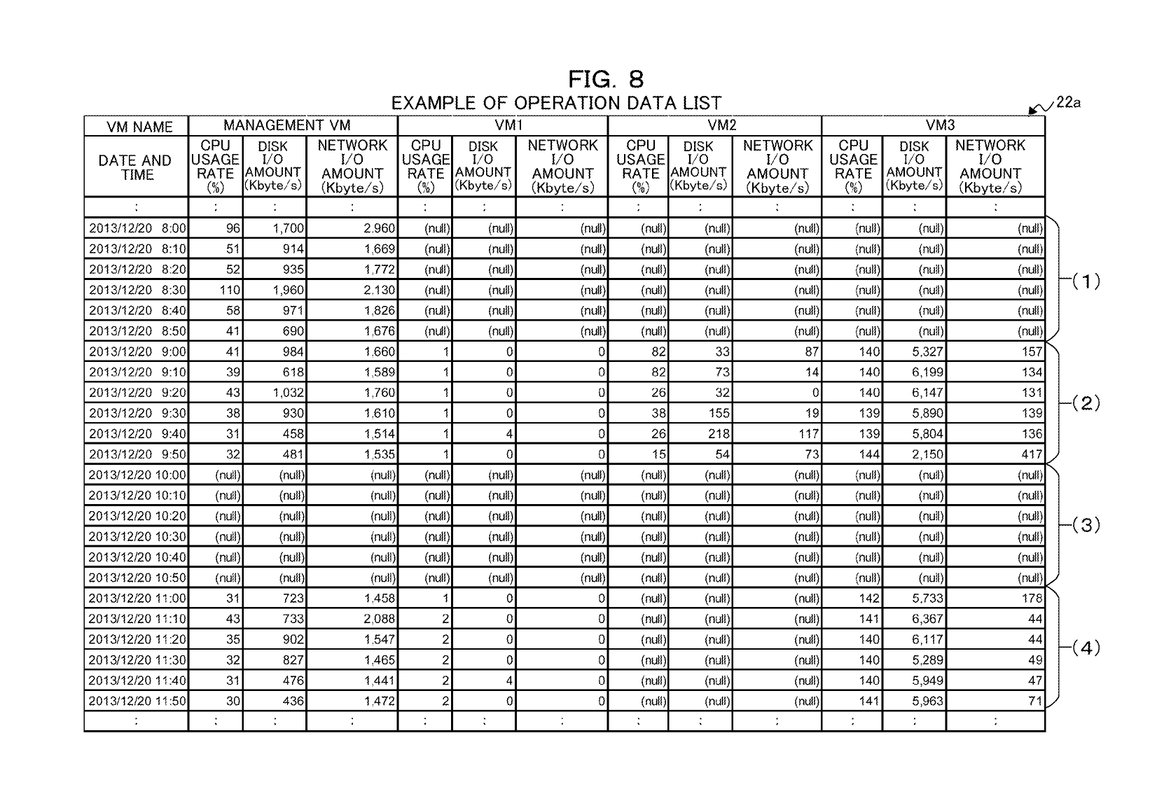

For example, a case is assumed in which the outputting server acquires operation data including a plurality of pieces of operating information depicted in FIG. 7 from the management virtual machine (VM). It is to be noted that, for the convenience of description, in the present contrast example, operation data is described with reference to a list of FIG. 8 (operation data list) in which operation data depicted in FIG. 7 are re-arranged. It is to be noted that, in FIGS. 7 and 8, a CPU usage rate (%) and data mounts (kbyte/second) of a disk I/O (Input/Output) and a network I/O of the management virtual machine (VM), a virtual machine VM1, another virtual machine VM2 and a further virtual machine VM3 are set as the operating information after every ten minutes. Further, in FIGS. 7 and 8, within a time zone within which “(null)” is set, operating information is not included (not sampled) due to power OFF to the virtual machine (VM) or a failure of the management virtual machine (VM).

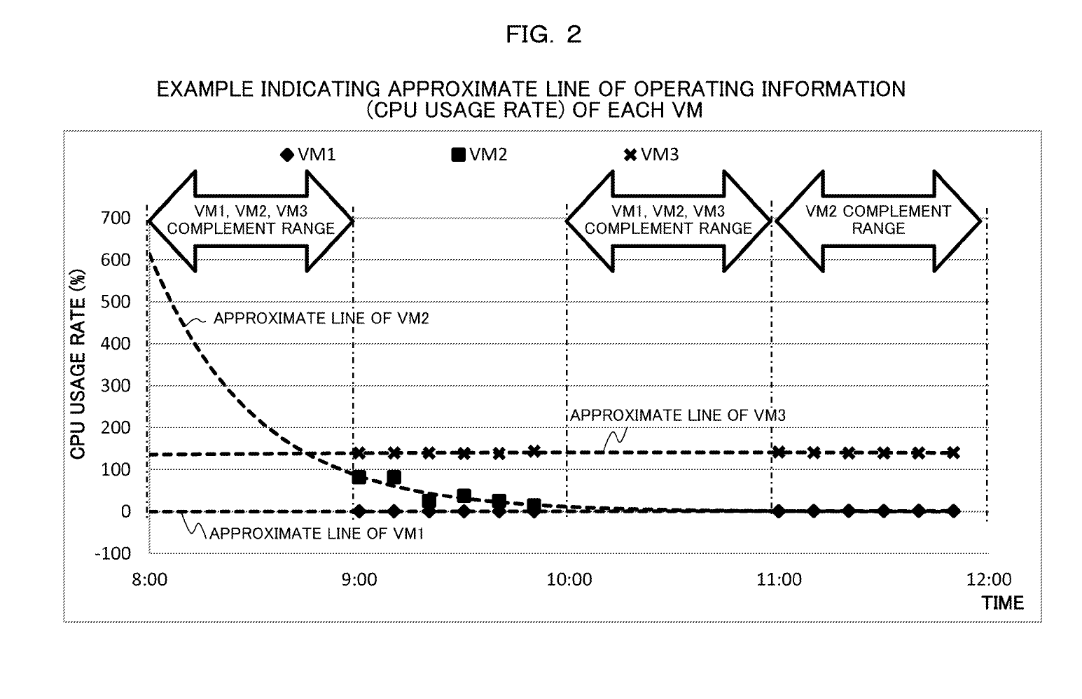

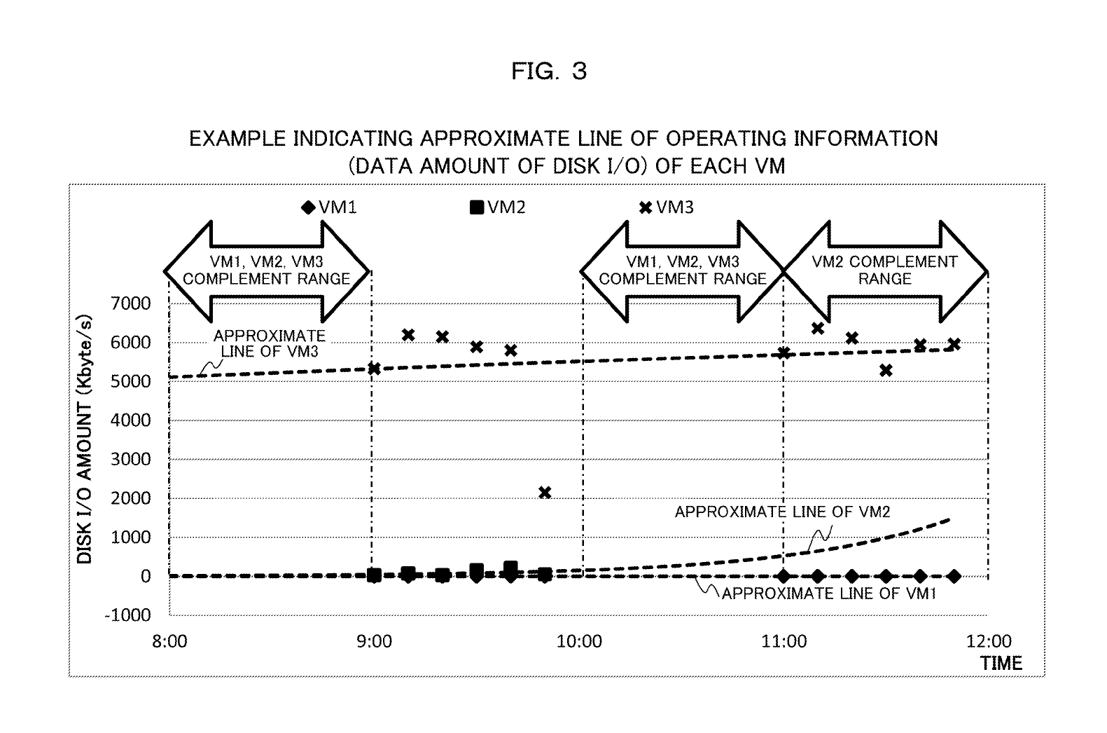

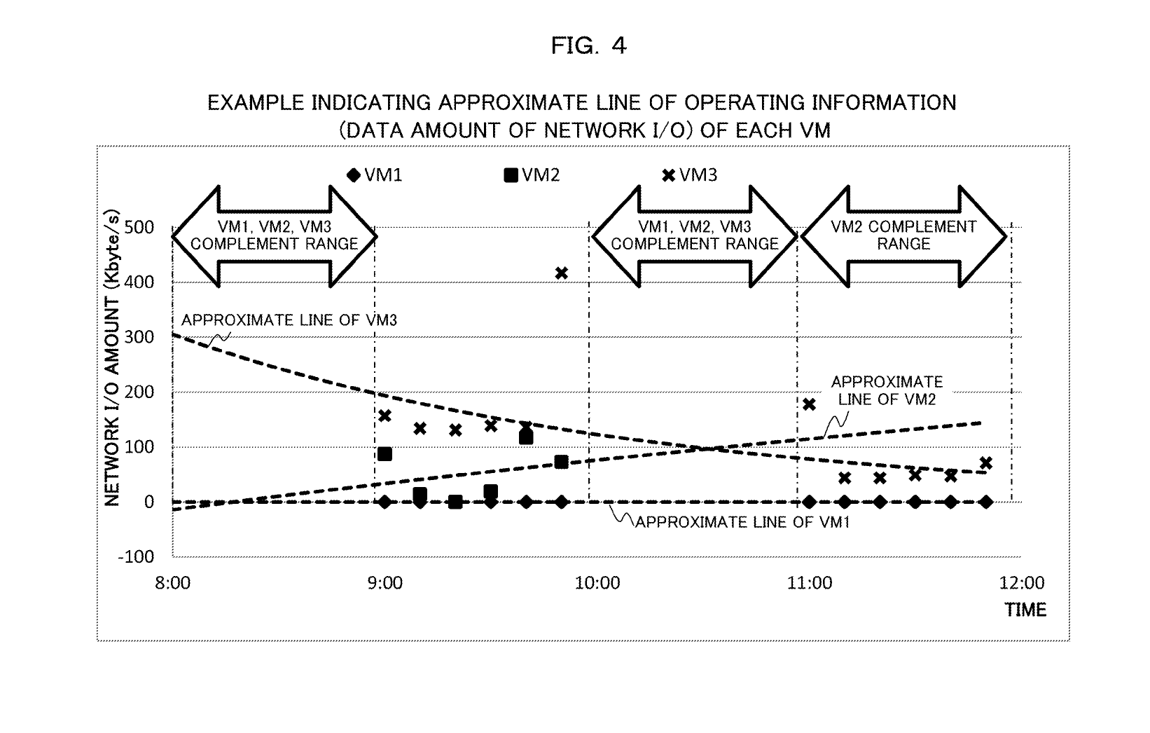

The outputting server calculates approximate lines exemplified in FIGS. 2 to 4 using data within a time zone within which there is operating information from within the operation data list depicted in FIG. 8. FIGS. 2 to 4 are views depicting approximate lines of operating information of each virtual machine (VM) used for data complementation to the operation data. As depicted in FIGS. 2 to 4, the outputting server decides all time zones within which there is no operating information (refer to (1) and (3) (between 8 and 9 a.m. and between 10 and 11 a.m.) of the virtual machines VM1, VM2 and VM3 and (4) (between 11 and 12 a.m.) of the virtual machine VM2 in FIG. 8) as time zones within which data is lost.

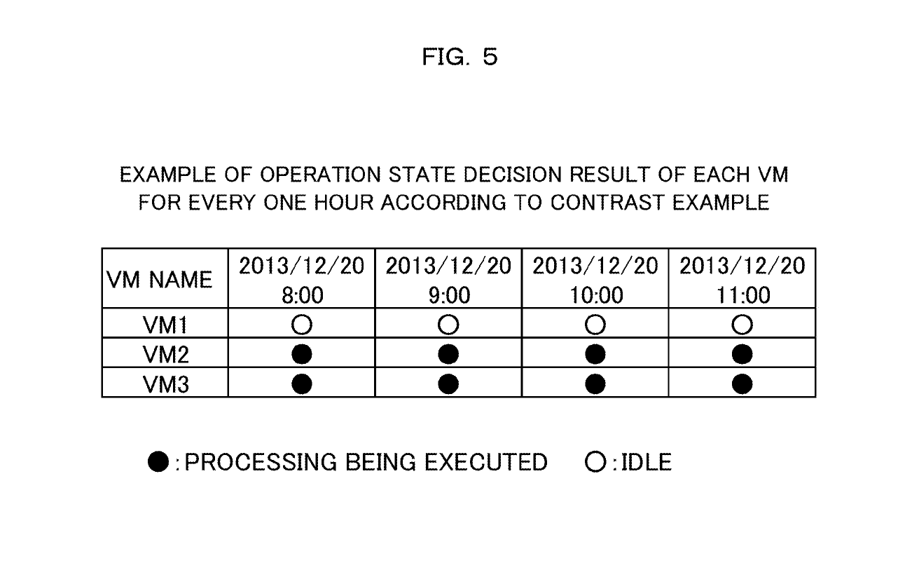

Then, the outputting server calculates data after the complementation within the time zones within which there is no data (between 8 and 9 a.m. and between 10 and 11 a.m. of the virtual machines VM1, VM2 and VM3 and between 10 and 11 a.m. of the virtual machine VM2) using values on the approximate lines of FIGS. 2 to 4. Further, the outputting server decides an operation situation of each virtual machine (VM) for every one hour on the basis of the data after the complementation, and such a result of the decision of an operation state for every one hour as depicted in FIG. 5 is obtained. It is to be noted that, in FIG. 5, a filled circle indicates that a process is being executed and an open circle indicates an idle state. In the example depicted in FIG. 5, the virtual machine VM1 is in an idle state within the entire time zone between 8 and 12 a.m. and the virtual machines VM2 and VM3 are in a state in which processing is being executed within the entire time zone between 8 and 12 a.m.

However, in FIG. 8, (1) (between 8 and 9 a.m.) of the virtual machines VM1, VM2 and VM3 and (4) (between 10 and 11 a.m.) of the virtual machine VM2 are time zones within which the power to the virtual machines (VMs) is held to OFF by the user. In particular, the data within the time zone between 8 and 9 a.m. of the virtual machines VM1, VM2 and VM3 and within the time zone between 10 and 11 a.m. of the virtual machine VM2 from among the results of FIG. 5 can be considered data obtained by addition of unnecessary complementation data as a result of determination that data is lost by a failure of the management virtual machine (VM) although the virtual machined (VMs) originally are in a power OFF state within the time zones. In this manner, even if the outputting server outputs the report of the operating information on the basis of FIG. 5, it is difficult to say that the report correctly visualizes the operation situation of the virtual machines (VMs), and the reliability of the report is low.

[3] One Embodiment

Since, in the contrast example, complementation is performed for all time zones within which there is no operating information in the operation data as described above with reference to FIGS. 2 to 5, the reliability of the report of the operating information is low. Further, if it is indicated in a result of decision of the operation situation that a time zone within which a virtual machine (VM) is in a power OFF state is indicated as a time zone within which processing is being executed, then this rather reminds the user of the necessity for continuous operation of the virtual machine (VM), and it sometimes becomes difficult to implement minimization of useless utilization of a resource by a virtual machine (VM) in an idle state.

In contrast, in a system according to one embodiment, the outputting server can decide whether a time zone within which there is no operating information in operation data is a time zone of “power OFF of the virtual machine (VM) by the user” or of “data loss by a failure of the management virtual machine (VM)”. Accordingly, the outputting server can perform complementation suitably for a time zone within which “data loss by a failure of the management virtual machine (VM)” occurs in the operation data, and the reliability of the report of the operating information can be enhanced. In the following, details of the system according to the present embodiment are described.

[3-1] System According to the One Embodiment

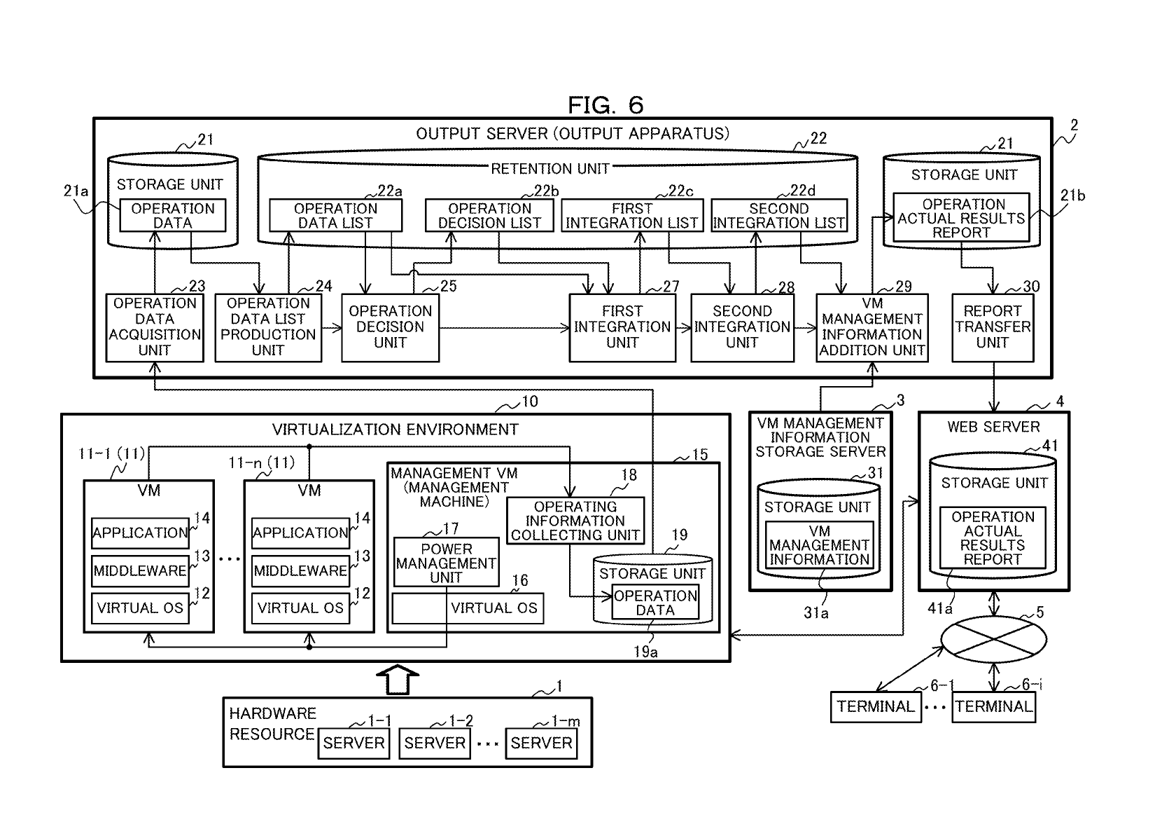

FIG. 6 is a view depicting an example of a configuration of the system according to the one embodiment. The system according to the one embodiment can exemplarily include, as hardware, a hardware resource 1, an outputting server 2, a VM management information storage server 3 and a Web server 4. It is to be noted that the hardware provided in the present system may be installed, for example, in a data center or the like, and at least part of the hardware may be provided in different facilities or the like such that communication with them is performed through a network in the system.

The hardware resource 1 includes m (m is an integer equal to or greater than one) servers 1-1 to 1-m, and implements a virtualization environment 10 using resources including the servers 1-1 to 1-m by a virtualization technology. Each of the servers 1-1 to 1-m can include, as resources used in the virtualization environment 10, for example, a processor such as a CPU, a storage apparatus such as a memory, an auxiliary storage apparatus such as a Hard Disk Drive (HDD) or a Solid State Drive (SSD), an interface such as a network card and so forth. It is to be noted that the servers 1-1 to 1-m are an example of an information processing apparatus.

The virtualization environment 10 is managed by a manager of the cloud system using the hardware resource 1. In the virtualization environment 10, n (n is an integer equal to or greater than 1) virtual machines (VMS) 11-1 to 11-n (in the following description, where the virtual machines VM11-1 to VM11-n are not distinguished from each other, each of them is hereinafter referred to simply as virtual machine VM11) and one or more (in FIG. 6, one) management virtual machine VM15 are provided exemplarily. In particular, the virtualization environment 10 implemented by the hardware resource 1 configures the cloud system that provides one or more virtual machines VM11 to the user.

The virtual machines VM11 are provided to user terminals 6-1 to 6-i (i is an integer equal to or greater than 1), for example, through the network 5 by the manager of the cloud system. It is to be noted that, as a providing method of a virtual machine VM11 to a user, various known methods can be used. As an example, the Web server 4 includes an application for performing control (utilization) of a virtual machine VM11, and the virtual machine VM11 is provided to a user by utilization of the virtual machine VM11 through the application by the user. It is to be noted that the network 5 may include the Internet, an intranet or a combination of them.

Each of the virtual machines VM11 exemplarily includes a virtual operating system (OS) 12 to be executed on a hyper visor not depicted, a predetermined application 14 to be executed by the user and middleware 13 for executing the application 14 on the virtual operating system (OS) 12.

The management virtual machine VM15 is used for management of the cloud system such as operation management of the virtual machines VM11 by the manager of the cloud system. For example, the management virtual machine VM15 can perform power management of the virtual machines VM11, sampling of operating information (behavior information) from the virtual machines VM11, production of operation data and so forth.

Exemplarily, the management virtual machine VM15 can include a virtual operating system (OS) 16 to be executed on the hypervisor, a power management unit 17, an operating information collecting unit 18 and a storage unit 19.

The power management unit 17 performs control of power to the virtual machines VM11 through the virtual operating system (OS) 16 and the hypervisor. For example, in accordance with a control instruction for power ON/OFF to a virtual machine VM11 from the user, the power management unit 17 controls ON control or OFF control of the power to the corresponding virtual machine VM11. In this manner, in the virtual machines VM11 in the present embodiment, the ON/OFF control of the power to a virtual machine VM11 by the user is executed through the power management unit 17 of the management virtual machine VM15. For example, when the user issues a controlling instruction for ON/OFF control of the power to a virtual machine VM11 from a site for management of the virtual machine VM11 provided by the Web server 4 or the like, a notification of the controlling instruction may be issued from the Web server 4 or the like to the power management unit 17.

It is to be noted that the power OFF control of a virtual machine VM11 may include control for saving, for example, information of the virtual machine VM11 into the auxiliary storage apparatus to release resources allocated to the virtual machine VM11 such as a CPU resource, a memory resource, a network resource and so forth. Meanwhile, the power ON control of a virtual machine VM11 may include a control for producing the virtual machine VM11 from a state of the virtual machine VM11 before power OFF saved in the auxiliary storage apparatus or the like, a template or the like and allocating a CPU resource, a memory resource, a network resource and so forth to the produced virtual machine VM11.

The operating information collecting unit 18 periodically collects operating information of the virtual machines VM11 through the virtual operating system (OS) 16 and the hypervisor and stores the collected information as operation data 19a exemplified in FIG. 7 into the storage unit 19. In the present embodiment, the operating information collecting unit 18 acquires the operating information in a unit of ten minutes from each virtual machine VM11. As the operating information collecting unit 18, an application to be executed on the virtual operating system (OS) 16 such as Systemwalker Service Quality Coodinator (SQC) that is a product for performing performance analysis or capacity management is available.

As an example, the operating information collecting unit 18 collects, after every ten minutes, the operating information indicating a resource utilization situation (operation situation) such as a CPU usage rate, a data amount of the disk I/O, a data amount of the network I/O and so forth of each virtual machine VM11 from each of the management virtual machine VM15 and the virtual machines VM11. It is to be noted that, as the operating information (behavior information), for example, an operating log that is utilization information of a resource relating to accounting of the cloud system is available. The operating log may include not only the data described above but also a disk usage rate and so forth.

FIG. 7 depicts a manner in which an operation situation is collected from the management virtual machine VM15 and the three virtual machines VM11 (represented as VM1, VM2 and VM3) at 8:00 and 8:10 (refer to (a) and (b)). It is to be noted that the operating information collecting unit 18 may collect, as the CPU usage rate, an average, a maximum value or the like among CPU usage rates of the virtual machines VM11 at each time point of the collection or CPU usage rates after the last collection to a next collection time point. Further, the operating information collecting unit 18 may collect a total value or the like of data amounts of each I/O after the last collection to the collection time point as data amounts of the disk I/O and the network I/O.

The storage unit 19 is a storage region for storing the operation data 19a collected by the operating information collecting unit 18 therein and is implemented by a storage apparatus such as a memory or an auxiliary storage apparatus such as an HDD from within the hardware resource 1.

In this manner, the management virtual machine VM15 can be regarded as an example of a management machine that performs acquisition of operating information relating to an operation situation within a predetermined period of the virtual machines VM11 operating on the servers 1-1 to 1-m and activation control of the virtual machines VM11.

As depicted in FIG. 6, the outputting server 2 copies the operation data 19a acquired by the management virtual machine VM15 (operation information collection unit 18) and classifies states of the virtual machines (VMs) from the operating information of the virtual machines (VMs) and then outputs a report in which the operation states are arranged in a time series for each virtual machine (VM). The report outputted from the outputting server 2 includes at least operation actual results in which operating information of the virtual machine (VM) within a period within which operating information is not acquired is supplemented. It is to be noted that the operation actual results may include an operation state indicating whether or not the virtual machine VM11 is operative within a predetermined period (power thereto is ON or OFF) and whether, where the virtual machine VM11 is operative (power ON), the virtual machine VM11 is in a processing execution state in which processing is being executed or in an idle state. The outputting server 2 can use the operating information to decide the operation state.

In the following description of the present embodiment, it is assumed that the outputting server 2 produces and outputs an operation actual results report 21b in a unit of one day taking operating information of virtual machines (VMs) within a period within which operating information is not acquired into consideration. The outputting server 2 may be implemented by an information processing apparatus as hardware or may be implemented by a virtual machine (VM) that operates using the hardware resource 1 or some other hardware resource. Details of the outputting server 2 are hereinafter described.

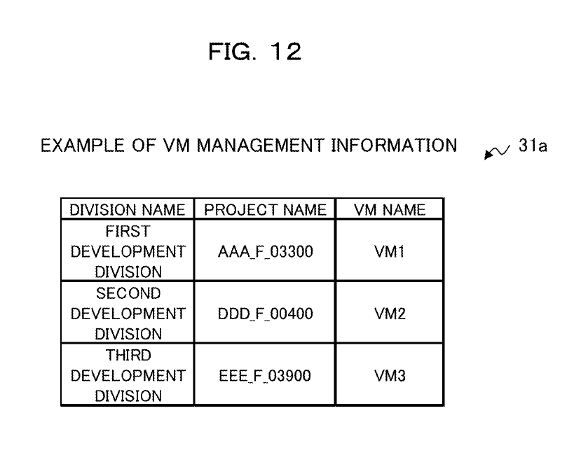

The VM management information storage server 3 stores management information (VM management information 31a; refer to FIG. 12) of the virtual machines VM11 provided in the cloud system. The VM management information 31a may include an office organization name (assigned department name) by which each virtual machine VM11 is owned (utilized), a project name, a manager name, a virtual machine (VM) name, a name of the user, a mail address and so forth. In the present embodiment, it is assumed that the VM management information 31a includes an office organization name, a project name, and a virtual machine (VM) name as exemplified in FIG. 12.

The VM management information storage server 3 can include the storage unit 31 for storing the VM management information 31a therein. The storage unit 31 is a storage region for storing the VM management information 31a therein and is implemented by an auxiliary storage apparatus such as an HDD.

The Web server 4 is a server for laying open the operation actual results report 21b produced by the outputting server 2. The Web server 4 can provide a report providing site for management of the virtual machines VM11 to a user (terminals 6-1 to 6-i), and the user can access the Web server 4 to read and download the operation actual results report 21b.

[3-2] Example of the Configuration of the Output Server

Now, a detailed configuration of the outputting server 2 is described. The outputting server 2 can exemplarily include a storage unit 21, a retention unit 22, an operation data acquisition unit 23, an operation data list production unit 24, an operation decision unit 25, a first integration unit 27, a second integration unit 28, a VM management information addition unit 29 and a report transfer unit 30.

The storage unit 21 is a storage apparatus capable of storing various data and programs therein. In the present embodiment, the storage unit 21 can store files such as the operation data 21a and the operation actual results report 21b therein. It is to be noted that the storage unit 21 is implemented by an auxiliary storage apparatus such as an HDD or an SSD.

The retention unit 22 is a storage apparatus capable of storing various data and programs therein. In the present embodiment, the retention unit 22 can store data such as an operation data list 22a, an operation decision list 22b, a first integration list 22c and a second integration list 22d therein. It is to be noted that the retention unit 22 is implemented by a storage unit such as a memory.

The operation data acquisition unit 23 acquires the operation data 19a such as data of Systemwalker Service Quality Coodinator (SQC) collected by the management virtual machine VM15 (operation information collection unit 18) and stores (copies) the operation data 19a into the storage unit 21 in the outputting server 2. In particular, the operation data acquisition unit 23 can be regarded as an example of an acquisition unit for acquiring operating information from the management virtual machine VM15. The acquisition of the operation data 19a by the operation data acquisition unit 23 can be performed by various known techniques such as, for example, the File Transport Protocol (FTP), and detailed description of the techniques is omitted. It is to be noted that the operation data 21a that is stored into the storage unit 21 by the operation data acquisition unit 23 is same as or substantially same as the operation data 19a (refer to FIG. 7).

The operation data list production unit 24 produces a list in which the operation data 21a stored in the storage unit 21 are arranged in a time series for each virtual machine (VM) and stores the produced list as the operation data list 22a exemplified in FIG. 8 into the retention unit 22.

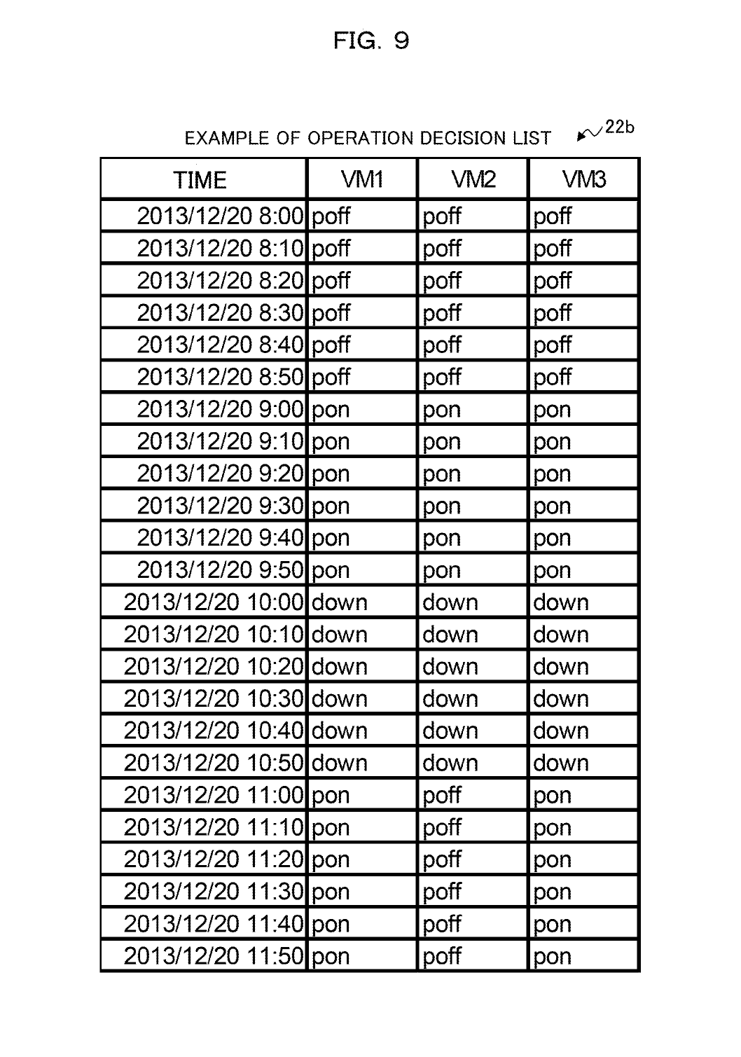

The operation decision unit 25 decides an operation state (operation state) of each virtual machine (VM) within each time zone from information of the management virtual machine VM15 and the virtual machines VM11 set in the operation data list 22a and stores a result of the decision as the operation decision list 22b exemplified in FIG. 9 into the retention unit 22. The operation state that can be decided by the operation decision unit 25 includes, for example, information that a virtual machine VM11 is in a power ON state, information that a virtual machine VM11 is in a power OFF state by the user and information that a failure occurs in the management virtual machine VM15. The operation decision unit 25 can decide an operation state for each virtual machine (VM), for example, on the basis of a set value (set state) of the CPU usage rate for the operation data list 22a.

As an example, where a CPU usage rate for the virtual machine VM11 is set in the operation data list 22a, the operation decision unit 25 decides that the virtual machine VM11 is in a power ON state that is a processing execution state in which processing is being executed or an idle state. It is to be noted that, in the example of FIG. 8, the virtual machines VM1, VM2 and VM3 within a time zone from 9:00 to 9:50 and the virtual machine VM1 and virtual machine VM3 within a time zone from 11:00 to 11:50 are a power ON state described above. As depicted in FIG. 9, with regard to the virtual machine VM11 decided to be in a power ON state, the operation decision unit 25 sets “pon” to the corresponding vertical machine VM11 within a corresponding time zone of the operation decision list 22b.

Further, while a CPU usage rate for the management virtual machine VM15 is set in the operation data list 22a, if a CPU usage rate of a virtual machine VM11 is not set, then the operation decision unit 25 decides that the virtual machine VM11 is placed in a power OFF state by the user. It is to be noted that, in the example of FIG. 8, the virtual machines VM1, VM2 and VM3 within a time zone from 8:00 to 8:50 and the virtual machine VM2 within a time zone from 11:00 to 11:50 are in a power OFF state by the user. Then, with regard to the virtual machine VM11 decided to be in a power OFF state, the operation decision unit 25 sets “poff” to the corresponding virtual machine VM11 within a corresponding time zone of the operation decision list 22b.

Further, where a CPU usage rate of the management virtual machine VM15 is not set in the operation data list 22a, the operation decision unit 25 decides that a failure occurs in the management virtual machine VM15. It is to be noted that, since the management virtual machine VM15 that collects operating information of the virtual machines VM11 suffers from a failure within the time zone, also a CPU usage rate of the virtual machines VM11 is not set (refer to VM1, VM2 and VM3 within the time zone from 10:00 to 10:50 in FIG. 8). Then, the operation decision unit 25 sets “down” to all virtual machines VM11 within the corresponding time zone of the operation decision list 22b.

In this manner, taking notice of a time zone within which operating information is not collected successfully, if collection of operating information of all virtual machines (VMs) including the management virtual machine VM15 at the same timing within the time zone results in failure, then the operation decision unit 25 can decide that data loss occurs because of a failure of the management virtual machine VM15.

On the other hand, if data collection is not completed successfully with regard to a certain virtual machine VM11 but is completed successfully with regard to some other virtual machine VM11, then the operation decision unit 25 can decide that the virtual machine VM11 with regard to which data collection is not completed successfully is in a power OFF state by the user. In other words, if a second period within which operating information of the management virtual machine VM15 is not acquired successfully is included in a first period within which there is no operating information of a virtual machine VM11, then the operation decision unit 25 can estimate that the operation state of the virtual machine VM11 within a period not included in the second period from within the first period is a stopping state.

In particular, the operation decision unit 25 can decide, on the basis of presence or absence (including a combination of such presence and absence) of an operating information log of a virtual machine VM11 and the management virtual machine VM15 that normally continues to operate during operation of the cloud system, whether the virtual machine VM11 is in a power OFF state or data loss by a failure of the management virtual machine VM15 occurs within a time zone within which the operating information of the virtual machine VM11 is lost. Accordingly, also where the operating information of a virtual machine VM11 is lost in the operation data list 22a, a power OFF state by voluntary stopping of the power to the virtual machine VM11 by the user can be identified. Therefore, the reliability of the operation actual results report 21b can be enhanced.

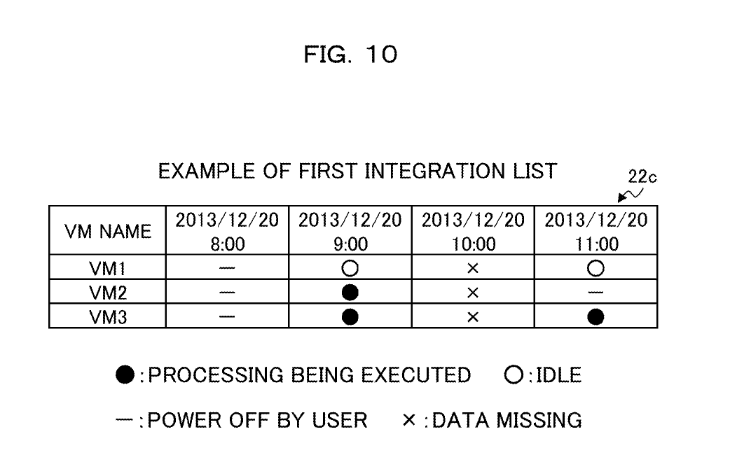

The first integration unit 27 performs a process for integrating operation states within a plurality of time zones of each virtual machine VM11 in the operation decision list 22b produced by the operation decision unit 25, and produces a first integration list 22c exemplified in FIG. 10 and stores the produced list into the retention unit 22. In the present embodiment, the first integration unit 27 performs an integration process of the operation decision lists 22b using one hour shorter than one day that is a totalization unit in the operation actual results report 21b as an integration unit.

For example, the first integration unit 27 reads out a plurality of (in this case, six) operation states in an integration unit (one-hour unit) from the operation decision unit 22b with regard to each virtual machine VM11, and decides an operation state within the integrated time zone in accordance with the following conditions.

(I) When the plurality of readout operation states include at least one “down”: it is decided that the integrated time zone is a time zone of data loss (decision impossible).

(II) When the plurality of read out operation states do not include “down” but include at least one “pon”: an idle decision process hereinafter described is performed using the operating information within the time zone (in a unit of ten minutes) in which “pon” is set.

(III) When none of the conditions (I) and above is satisfied: it is decided that, within the integrated time zone, the virtual machine VM11 is in a power OFF state.

As an example, a case is described in which the first integration unit 27 performs integration of operation states for every one hour (between 8 and 9 a.m., between 9 and 10 a.m., between 10 and 11 a.m. and between 111 and 12 a.m.) in the operation decision list 22b depicted in FIG. 9. Note that it is assumed that, as threshold values for the elements of the operating information, a threshold value for the CPU usage rate: 7.5%, a threshold value for the disk I/O amount: 400 kbyte/second, and a threshold value for the network I/O amount: 20 kbyte/second are set in the first integration unit 27. Further, it is assumed that, as a predetermined threshold value for deciding whether a virtual machine (VM) is in an operation processing state or an idle state, a ratio of an idle time period to a time period of an integration unit: 80.2% is set.

For example, since “down” is set in all of six time zones (unit of ten minutes) for the virtual machines VM1 to VM3 between 10 and 11 a.m., the first integration unit 27 decides that the integrated time zone is a time zone of data loss on the basis of the condition (I) described above. Then, as depicted in FIG. 10, the first integration unit 27 sets a cross mark (x) indicative of data loss for the virtual machines VM1 to VM3 between 11 and 12 a.m.

Further, since “pon” is set to all of the time zones (unit of ten minutes) between 9 and 10 a.m. of the virtual machines VM1, VM2 and VM3 and between 11 and 12 a.m. of the virtual machines VM1 and VM3, the first integration unit 27 performs an idle decision process on the basis of the condition (II) described above. In the idle decision process, the first integration unit 27 decides whether the operation state within the integrated time zone is a processing execution state and an idle state in the power ON state.

For example, the first integration unit 27 refers to the operation data list 22a to decide whether or not at least one of the elements (CPU usage rate, disk I/O amount and network I/O amount) of the operating information within the time zones to which “pon” is set is lower than the threshold value. Then, the first integration unit 27 calculates the total of time periods within which all of the elements are lower than the threshold value within the time zone in an integration unit including the time zone with regard to which the decision is performed. Then, the first integration unit 27 decides that the operation state is an idle state if the ratio of the calculated total of time periods to the time zone of the integration unit is higher than the predetermined threshold value, but decides that the operation state is a processing execution state if the ratio of the calculated total is equal to or lower than the predetermined threshold value.

In the examples depicted in FIGS. 8 and 9, the first integration unit 27 decides that all elements are lower than the threshold values within all of the six time zones between 9 and 10 a.m. and between 11 and 12 a.m. of the virtual machine VM1. Then, the first integration unit 27 decides that the ratio of the total of time periods within which all elements are lower than the threshold value to the time zone (one hour) of the integration unit is higher than a ratio (predetermined threshold value) of idle time, and decides that the virtual machine VM1 is in the idle state within the time zones. Then, as depicted in FIG. 10, the first integration unit 27 sets an open circle (0) indicative of an idle state between 9 and 10 a.m. and between 11 and 12 a.m. of the virtual machine VM1.

Further, the first integration unit 27 decides that at least one of the elements is equal to or higher than the threshold value within all of the six time zones between 9 and 10 a.m. of the virtual machine VM2 and between 11 and a.m. of the virtual machine VM3. Then, the first integration unit 27 decides that the ratio of the total of time periods within which the element is equal to higher than the threshold value to the time zone (one hour) of the integration unit is lower than a ratio (predetermined threshold value) of the idle time, and decides that the virtual machines VM2 and VM3 are in a processing execution state within the time zones. Then, as depicted in FIG. 10, the first integration unit 27 sets a filled circle (•) indicative of a processing execution state between 9 and 10 a.m. and between 11 and 12 a.m. of the virtual machine VM2 and between 11 and 12 a.m. of the virtual machine VM3.

Further, the first integration unit 27 decides that neither “down” nor “pon” is set between 8 and 9 a.m. of the virtual machines VM1 and VM3 and between 8 and 9 a.m. and between 11 and 12 a.m. of the virtual machine VM2 (the conditions (I) and (II) given hereinabove are not satisfied). It is to be noted that this signifies that “poff” is set to all of the six time zones (unit of ten minutes). Then, the first integration unit 27 decides on the basis of the condition (III) given hereinabove that the virtual machines (VMs) are in a power OFF state within the time zones. Then, as depicted in FIG. 10, the first integration unit 27 sets a hyphen (-) indicative of a power OFF state between 8 and 9 a.m. of the virtual machines VM1 and VM3 and between 11 and 12 a.m. of the virtual machine VM2.

It is to be noted that characters of a filled circle (•), an open circle (∘), a hyphen (-) and a cross mark (x) indicative of the operation states set in the first integration list 22c are exemplary and are not restrictive. The operation states can be represented by various techniques such as, for example, by representation of a binary number of 2 bits.

In this manner, the first integration unit 27 performs a state decision for every one hour for producing an operation actual results report 21b on the basis of the operation data list 22a and the operation decision list 22b. At this time, the first integration unit 27 can decide in the integration process whether the virtual machine (VM) is in a processing execution state or in an idle state within a time zone of a power ON state in the operation data list 22a. Consequently, the time zone of the power ON state can be specified to one of a processing execution state and an idle state, and the reliability of the operation actual results report 21b can be enhanced.

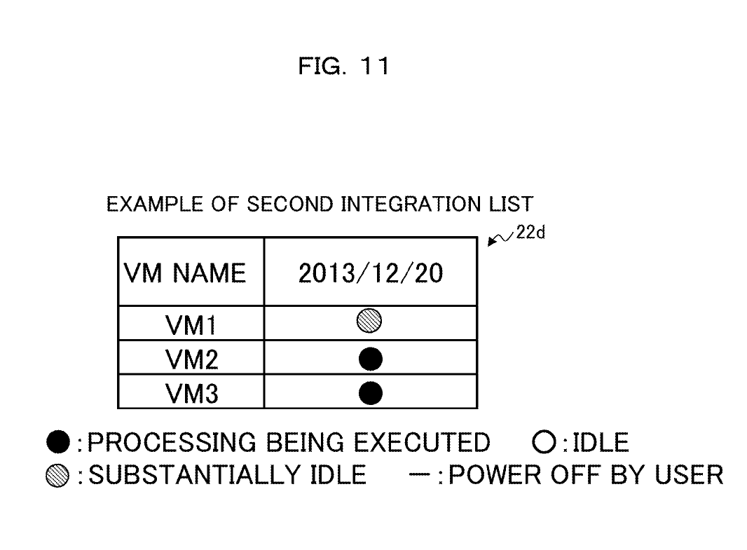

The second integration unit 28 performs a process for integrating operation states within a time zone of a plurality of integration units of each virtual machine VM11 to a totalization unit in the operation actual results report 21b for the first integration list 22c for which the integration process has been performed by the first integration unit 27. Then, the second integration unit 28 produces a second integration list 22d exemplified in FIG. 11 and stores the produced second integration list 22d into the retention unit 22. In the present embodiment, the second integration unit 28 performs the integration process of the operation states in a unit of one hour of the first integration list 22c taking one day that is a totalization unit in the operation actual results report 21b as an integration unit.

It is to be noted that, in the following description, it is a premise that, even if a failure occurs, the management virtual machine VM15 is restored within 24 hours, and a case in which all time zones within 24 hours exhibit a data loss state (decision impossible) is excluded. This is because, when the management virtual machine VM15 stops from a failure, it is frequently restored in approximately 6 hours and it is a rare case that a failure of the management virtual machine VM15 occurs continuously for 24 hours. Also it is a reason that, if such a failure that the management virtual machine VM15 continues to be down for more than 24 hours occurs, then the operation state at this time does not have appealing power for reduction of idle virtual machines (VMs).

The second integration unit 28 reads out a plurality of (in this case, 24) operation states in an integration unit (unit of one day) from the first integration list 22c, for example, with regard to each virtual machine VM11, and decides an operation state within an integrated time zone (one day) in accordance with conditions described below.

(1) When the plurality of readout operation states include at least one processing execution state (filled circle: •): since there are actual results that a process is executed, it is decided that the integrated time zone is a time zone in a processing execution state.

(2) When the plurality of readout operation states include no processing execution state but include at least one data loss (cross mark: x):

(2-1) When the time zone just before that of the data loss indicates an idle state (open circle: ∘): since it can be decided that a time zone other than that within which a failure occurs in the management virtual machine VM15 is a time zone of an idle state, it is decided that the integrated time zone indicates a substantially idle state.

(2-2) When the time zone just before that of the data loss indicates a power OFF state (hyphen: -):

(2-2-1) When all time zones other than the time zone of data loss indicate a power OFF state: it is decided that the integrated time zone is a time zone in a power OFF state.

(2-2-2) When the time zones other than the time zone of data loss include at least one idle state: it is decided that the integrated time zone indicates an idle state.

(3) When the plurality of readout operation states include no processing execution state and no data loss:

(3-1) When all time zones indicate a power OFF state: it is decided that the integrated time zone indicates a power OFF state.

(3-2) When the plurality of read out operation states include at least one idle state: it is decided that the integrated time zone indicates an idle state.

It is to be noted that, in a day for which the decision of “substantially idle state” is made in the condition (2-1) above, the operation state within the time zone of data loss is unknown. However, since a time zone within which data exists normally indicates an idle state and also immediately preceding data indicates an idle state, there is the possibility that the virtual machine VM11 may be left in an idle state for a long period of time within the day. Therefore, where the condition (2-1) described above is satisfied, by setting the day as a day in a “substantially idle state”, reduction and power OFF of unnecessary virtual machines VM11 can be emphasized to the user similarly to a day determined as a day of an idle state and suppression of useless utilization of a resource can be anticipated.

As an example, a case is described in which the second integration unit 28 performs integration of operation states in the first integration list 22c depicted in FIG. 10 into an operation state for one day. It is to be noted that, while the second integration unit 28 uses operation states for 24 hours, only operation states four 4 hours are depicted in FIG. 10. In the following description, for the simplification of description, it is assumed that the second integration unit 28 integrates operation states for 4 hours into an operation state for one day.

For example, the second integration unit 28 decides that no processing execution state is found with regard to the virtual machine VM1 and besides the immediately preceding data to data loss (between 10 and 11 a.m.) indicates an idle state (between 9 and 10 a.m.). Accordingly, the second integration unit 28 estimates on the basis of the condition (2-1) described above that the location at which the data loss is indicated indicates an idle state with a high degree of probability, and sets a slanting line circle indicating a substantially idle state to the virtual machine VM1 as depicted in FIG. 11.

Further, the second integration unit 28 decides that a processing execution state is indicated between 9 and 10 a.m. with regard to the virtual machine VM2. Accordingly, the second integration unit 28 sets a filled circle (•) indicative of a processing execution state to the virtual machine VM2 as depicted in FIG. 11 on the basis of the condition (1) described above.

Further, the second integration unit 28 decides that a processing execution state is indicated between 9 and 10 a.m. and between 11 and 12 a.m. with regard to the virtual machine VM3 similarly to the virtual machine VM2. Accordingly, the second integration unit 28 sets a filled circle (•) indicative of a processing execution state also to the virtual machine VM3 as depicted in FIG. 11 on the basis of the condition (1) described above.

In this manner, the second integration unit 28 estimates the operation state of the virtual machine VM11 within a predetermined period on the basis of the operation state of the virtual machine VM11 estimated within a first period within which there is no operating information and another operation state of the virtual machine VM11 within at least one of preceding and succeeding periods to the first period.

As described above, with the second integration unit 28, even if a failure occurs over 6 hours, for example, in the management virtual machine VM15, the operation state within one day can be decided from the remaining 18 hours. Accordingly, the operation state of the virtual machine VM11 in a processing execution state or a power OFF state can be decided correctly, and even if the virtual machine VM11 executes a process within a time zone of data loss, a result of the decision in accordance with an actual situation can be obtained without making an error decision that the virtual machine VM11 is in an idle state.

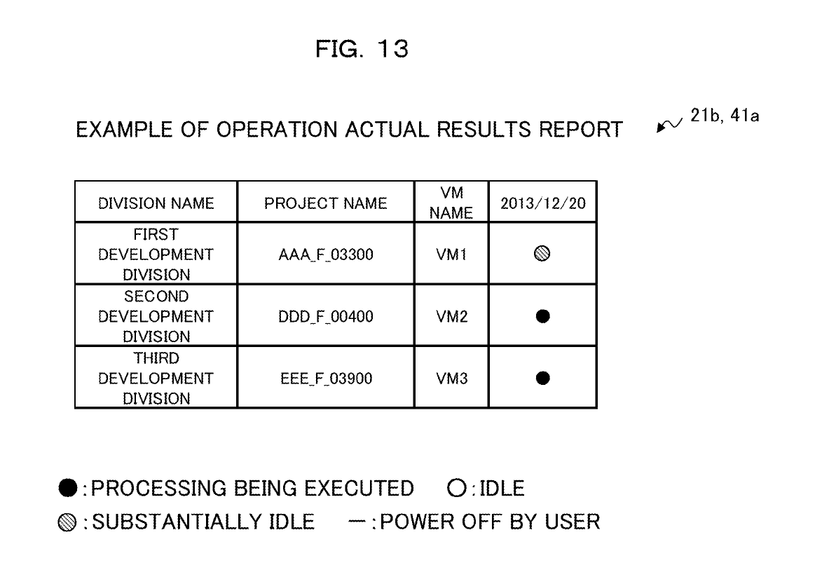

The VM management information addition unit 29 extracts VM management information 31a of each virtual machine (VM) from the VM management information storage server 3 (refer to FIG. 12). Then, the VM management information addition unit 29 merges the extracted information with the information of the second integration list 22d produced by the second integration unit 28 to produce an operation actual results report 21b as exemplified in FIG. 13 and stores the produced operation actual results report 21b into the storage unit 21. It is to be noted that the acquisition method of the VM management information 31a can be implemented by various known techniques. In the present embodiment, the VM management information addition unit 29 acquires the VM management information 31a through access and reference to the storage unit 31 that is a database of the VM management information 31a.

The report transfer unit 30 transfers the operation actual results report 21b stored in the storage unit 21 to the Web server 4 by a technique such as, for example, the FTP.

As described above, the outputting server 2 has a function as an estimation unit for estimating operation actual results of the virtual machine VM11 within a first period on the basis of operating information of the management virtual machine VM15 within the first period and operating information of the virtual machine VM11 acquired within at least one of preceding and succeeding periods to the first period. For example, in one form, the operation decision unit 25, first integration unit 27 and second integration unit 28 can be considered as an example of the estimation unit. Further, the report transfer unit 30 can be considered as an example of an output unit for outputting operation actual results of the virtual machine VM11 within the period (first period) within which operating information is not acquired.

[3-3] Example of Display of the Operation Actual Results Report

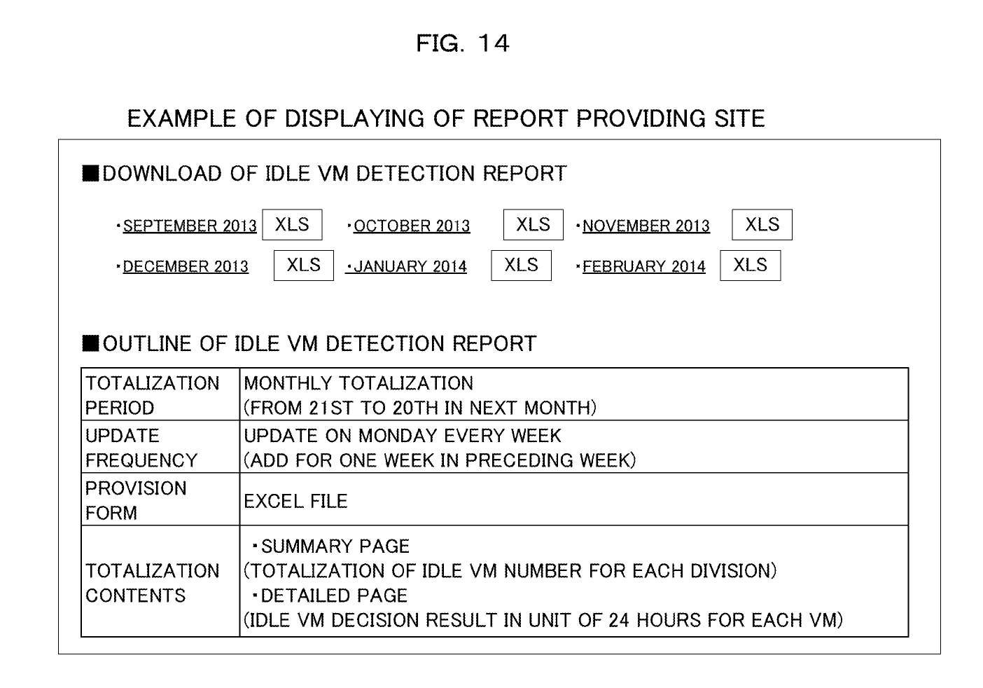

The operation actual results report 21b transferred from the outputting server 2 to the Web server 4 is, for example, stored as an operation actual results report 41b into the storage unit 41 by the Web server 4. Then, as exemplified in FIG. 14, the operation actual results report 41b is permitted to download from a report providing server to a user of the cloud system.

It is to be noted that the operation actual results report 41b can be configured in a data format such as, for example, XLS, CSV or TSV. In order to configure the operation actual results report 41b in the format, data conversion may be performed by the outputting server 2 (second integration unit 28, VM management information addition unit 29 or report transfer unit 30) or by the Web server 4 or the like.

As depicted in FIG. 14, the user can download the operation actual results report 41b for an arbitrary month by clicking the arbitrary month from “Download of idle VM detection report” displayed on the screen of any of the terminals 6-1 to 6-i.

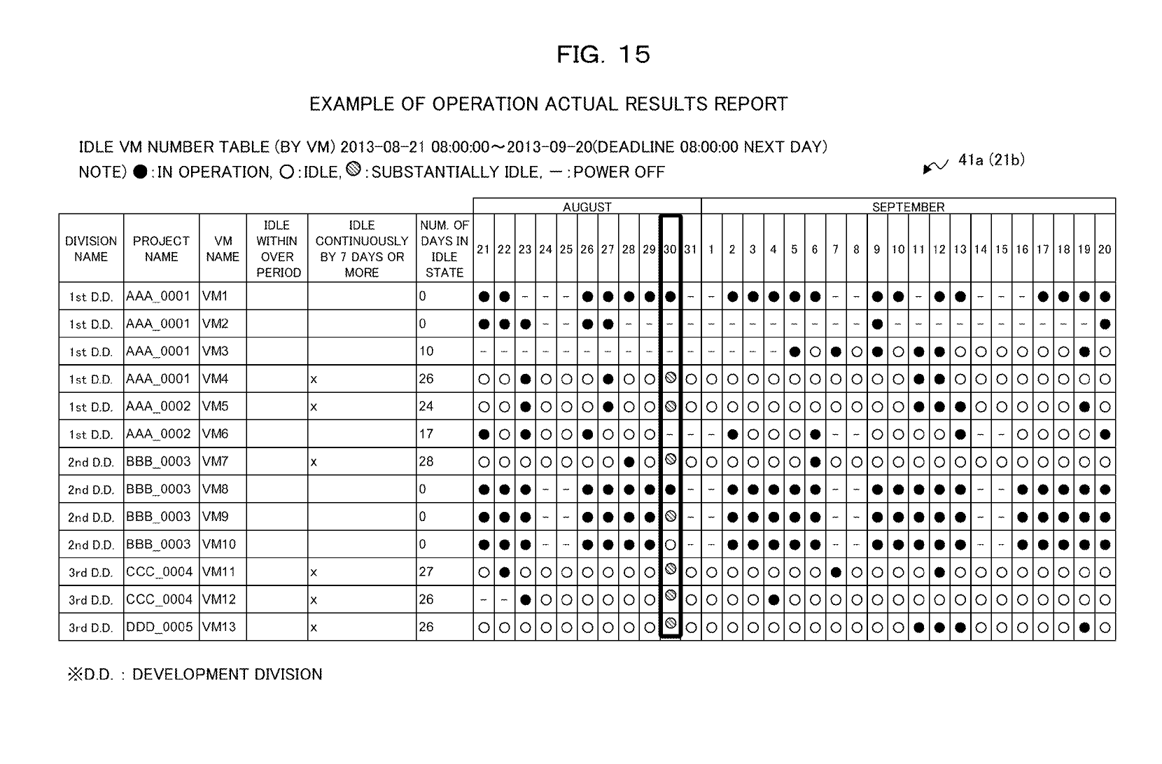

FIG. 15 depicts an example of the operation actual results report 41b of the cloud system that includes 30 servers 1-1 to 1-n provided by the Web server 4, 1500 virtual machines VM11 and a single management virtual machine VM15. In FIG. 15, part of a report of operation states of the virtual machines VM11 in the September period (from August 21 to September 20) is excerpted. It is to be noted that the operation actual results report 41b may suitably include additional items such as “Idle within whole period”, “Idle continuously for seven days or more”, “Number of days in an idle state” and so forth as depicted in FIG. 15.

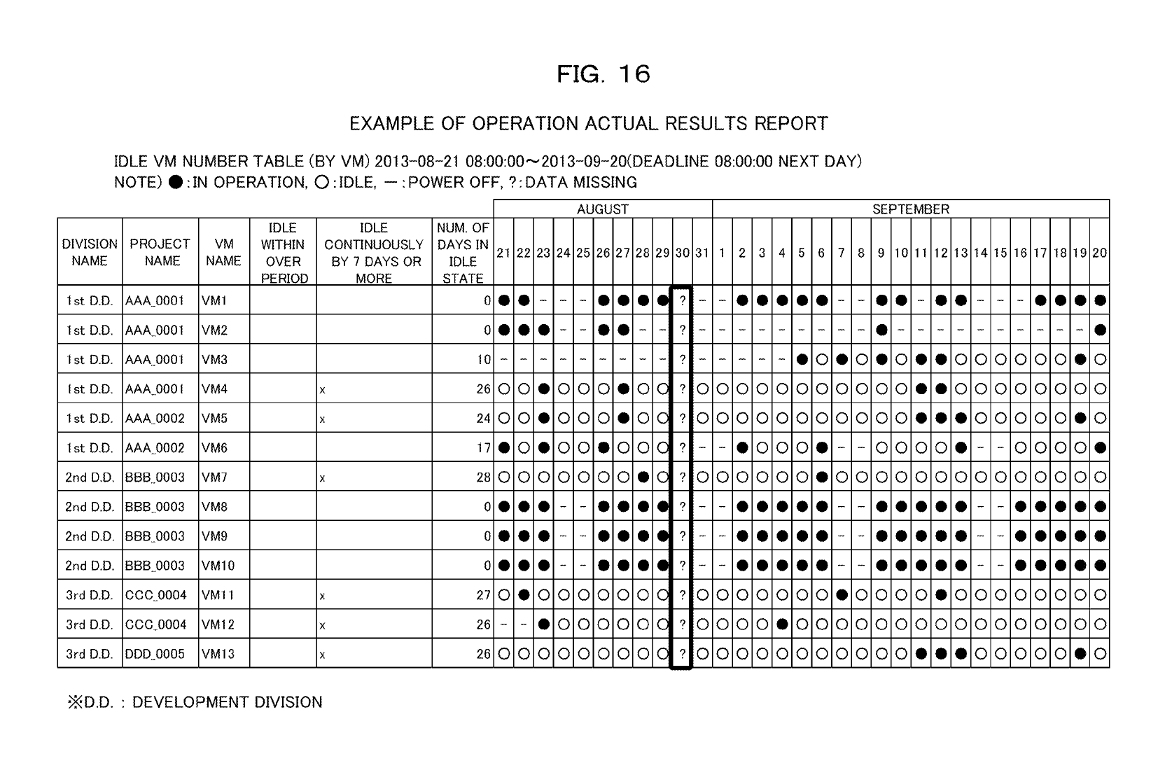

In the example of FIG. 15, data loss appears on August 30. Since decision in a unit of one day including a data loss location is not performed conventionally, the data on August 30 is represented as data loss (represented by “?” in the report) as depicted in FIG. 16.

In contrast, in the present embodiment, a decision method of an operation state in a unit of one day including a data loss location is used for the data on August 30. Consequently, the user can easily grasp a virtual machine VM11 in an idle state and another virtual machine VM11 decided to be, although the operation state upon data loss is unknown, in a “substantially idle state” from a result of decision of operation states within the other time zones as depicted in FIG. 15. Accordingly, the manager of the cloud system can urge the user of the virtual machine VM11 estimated as an unnecessary virtual machine (VM) to turn off the power (power OFF) to the virtual machine VM11 and can implement suppression of useless utilization of the resource.

[3-4] Example of the Operation of the Output Server

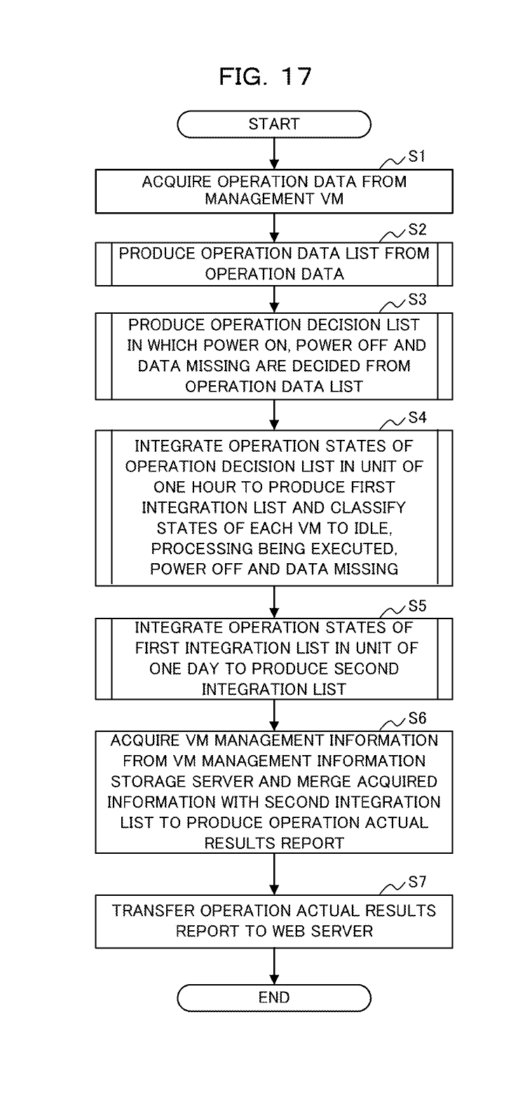

Now, an example of operation of the outputting server 2 configured in such a manner as described above is described with reference to FIGS. 17 to 22.

First, an example of operation of a production process of an operation actual results report 21b by the outputting server 2 is described with reference to a flow chart depicted in FIG. 17. It is to be noted that, as a premise, the management virtual machine VM15 of the cloud system collects operating information from each virtual machine VM11 after every 10 minutes and stores the collected information as the operation data 19a into the storage unit 19. Further, it is assumed that the operation actual results report 21b is tabulated for every month period and the outputting server 2 performs the production process of the operation actual results report 21b after every one week and then adds the produced report for 7 days to the operation actual results report 21b (file in the month period) of the Web server 4.

First, as depicted in FIG. 17, the operation data acquisition unit 23 of the outputting server 2 acquires operation data 19a from the management virtual machine VM15 and copies the acquired data as operation data 21a into the storage unit 21 (step S1). Then, the operation data list production unit 24 produces an operation data list 22a on the basis of the operation data 21a (step S2), and stores the produced operation data list 21a into the retention unit 22.

Then, the operation decision unit 25 decides power ON, power OFF and occurrence of a failure in the management virtual machine VM15 (occurrence of data loss) regarding the operation state on the basis of the operation data list 22a of the retention unit 22 to produce an operation decision list 22b (step S3). The operation decision list 22b is stored into the retention unit 22.

Then, the first integration unit 27 integrates the operation states of the operation decision list 22b in a unit of one hour to produce a first integration list 22c and then stores the produced first integration list 22c into the retention unit 22. At this time, the first integration unit 27 classifies the operation states of the virtual machines VM11 into idle, processing being executed, power OFF and data loss (decision impossible) (step S4). Then, the second integration unit 28 integrates the operation states in the first integration list 22c in a unit of one day to produce a second integration list 22d (step S5), and then stores the produced second integration list 22c into the retention unit 22.

The VM management information addition unit 29 acquires VM management information 31a from the VM management information storage server 3 and merges the VM management information 31a with the second integration list 22d to produce an operation actual results report 21b, and stores the produced operation actual results report 21b into the storage unit 21 (step S6). Then, the report transfer unit 30 transfers the operation actual results report 21b to the Web server 4 so as to be stored (step S7), and the processing by the outputting server 2 ends therewith. It is to be noted that details of the processes at steps S2 to S5 are hereinafter described.

[3-4-1] Example of the Operation Data List Production Process

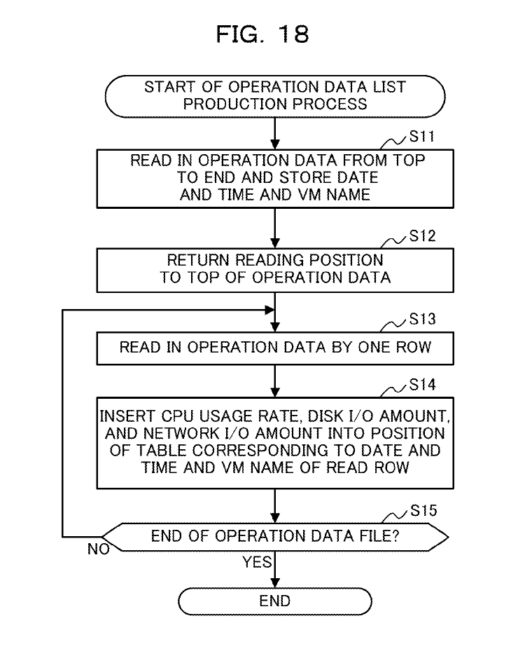

Now, an example of operation of the operation data list production unit 24 (detailed example of step S2 of FIG. 17) is described with reference to a flow chart of FIG. 18.

As depicted in FIG. 18, the operation data list production unit 24 reads in a file of the operation data 21a of the storage unit 21 from the top to the end, and stores date and time (collection date and time) and a virtual machine (VM) name set in the operation data 21a (step S11). The stored date and time and virtual machine (VM) name are used by the operation data list production unit 24 to grasp a number of columns and a number of records of a table of the operation data list 22a and produce an operation data list 22a.

Then, the operation data list production unit 24 returns the reading position to the top of the operation data 21a (step S12), and reads in the operation data 21a by one row (step S13). Further, the operation data list production unit 24 inserts values of a CPU usage rate, a disk I/O amount and a network I/O amount into positions of the table corresponding to the date and time and the virtual machine (VM) name in the row read in (step S14).

Then, the operation data list 22a decides whether or not the reading position at present is the end of the file of the operation data 21a (step S15). If the reading position at present is not the end of the file (No at step S15), then the processing advances to step S13. On the other hand, if the reading position at present is the end of the file (Yes at step S15), then the processing is ended. The process of the operation data list production unit 24 ends therewith.

[3-4-2] Example of the Operation Decision List Production Process

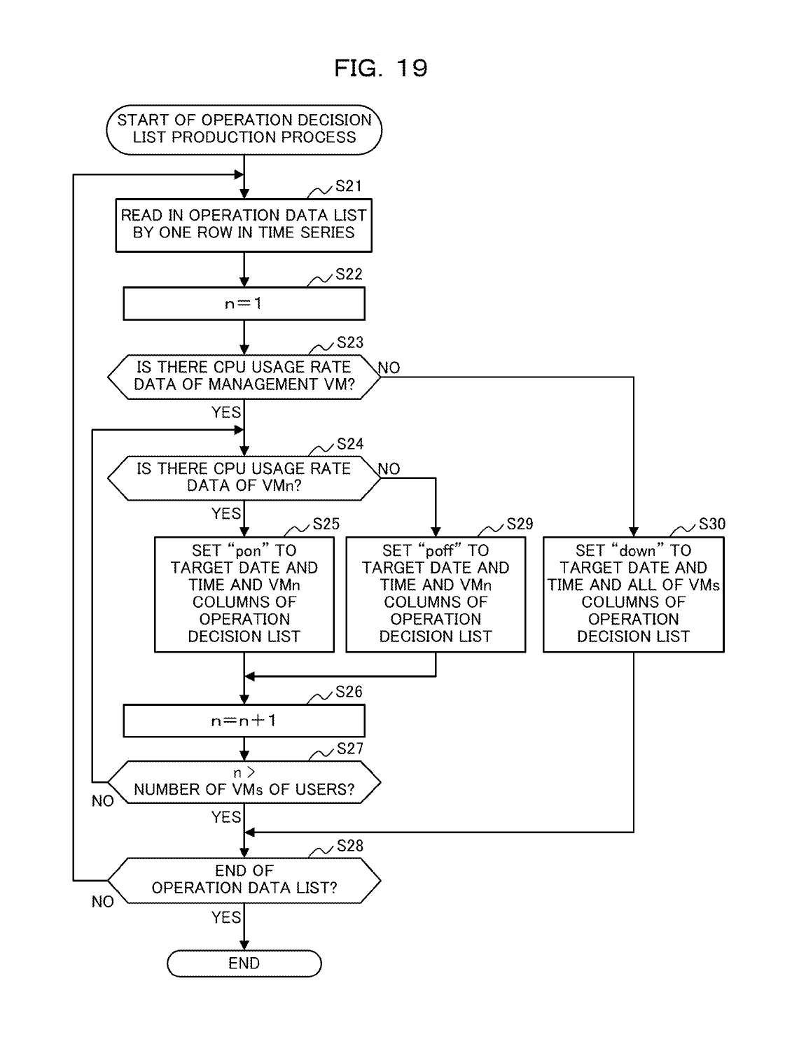

Now, an example of operation of the operation decision unit 25 (detailed example of step S3 of FIG. 17) is described with reference to a flow chart of FIG. 19.

As depicted in FIG. 19, the operation decision unit 25 reads in the operation data list 22a of the retention unit 22 by one row (step S21) and defines a variable n for identification of a virtual machine VM11 (n=1; step S22). Then, the operation decision unit 25 decides whether or not there is data of the CPU usage rate of the management virtual machine VM15 in the information read in (step S23). If there is data of the CPU usage rate of the management virtual machine VM15 (Yes at step S23), then the operation decision unit 25 decides whether or not there is data of the CPU usage rate of the virtual machine VMn in the read-in information (step S24).

If there is data of the CPU usage rate of the VMn in the read-in information (Yes at step S24), then the operation decision unit 25 sets “pon” to the VMn field in the target date and time of the operation decision list 22b (step S25), and increments n (step S26). Then, the operation decision unit 25 decides whether or not n is greater than the number of virtual machines (VMs) of the user (step S27). Then, if n is not greater than the virtual machine (VM) number (No at step S27), then the processing advances to step S24.

On the other hand, If n is greater than the number of virtual machines (VMs) of the user (Yes at step S27), then the operation decision unit 25 decides whether or not the reading position at present is the end of the operation data list 22a (step S28). If the reading position at present is not the end (No at step S28), then the processing advances to step S21. On the other hand, if the reading position at present is the end (Yes at step S28), then the processing is ended.

On the other hand, if there is no data of the CPU usage rate of the VMn in the read information at step S24 (No at step S24), then the operation decision unit 25 sets “poff” to the VMn field for the target date and time of the operation decision list 22b (step S29), and the processing advances to step S26.

On the other hand, if there is no data of the CPU usage rate of the management virtual machine VM15 in the read-in information at step S23 (No at step S23), then the operation decision unit 25 sets “down” to all virtual machine (VM) fields for the target date and time of the operation decision list 22b (step S30), and the processing advances to step S28. The process of the operation decision unit 25 ends therewith.

[3-4-3] Example of the Integration Process of the First Integration Unit

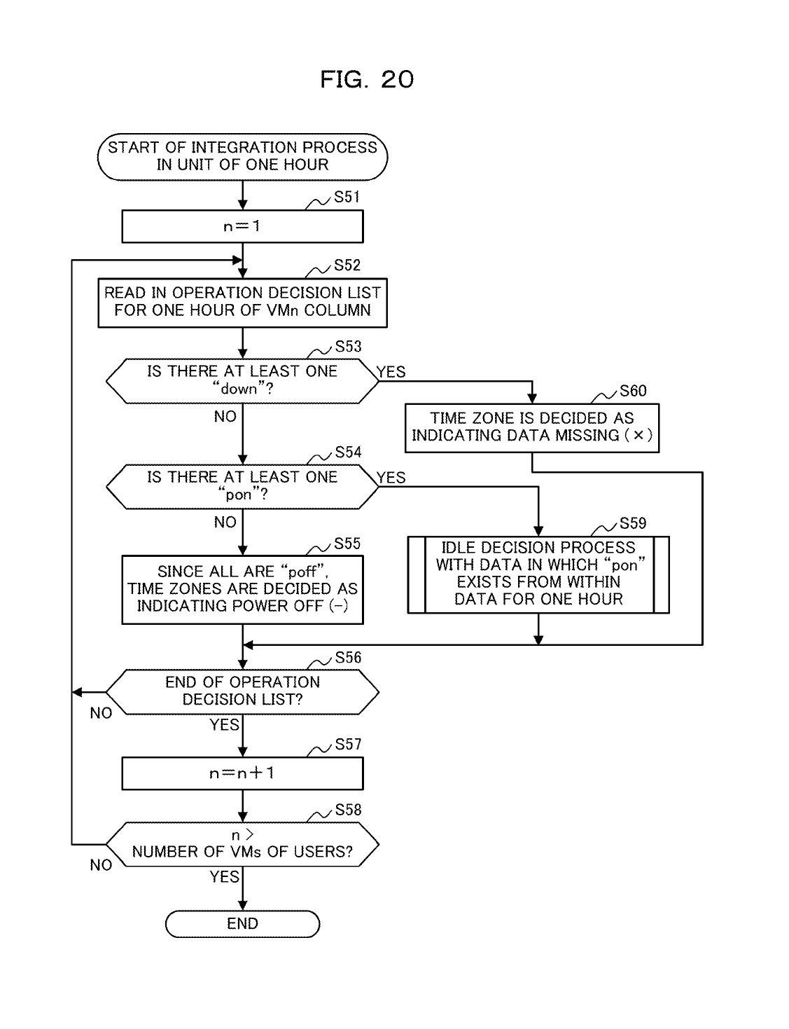

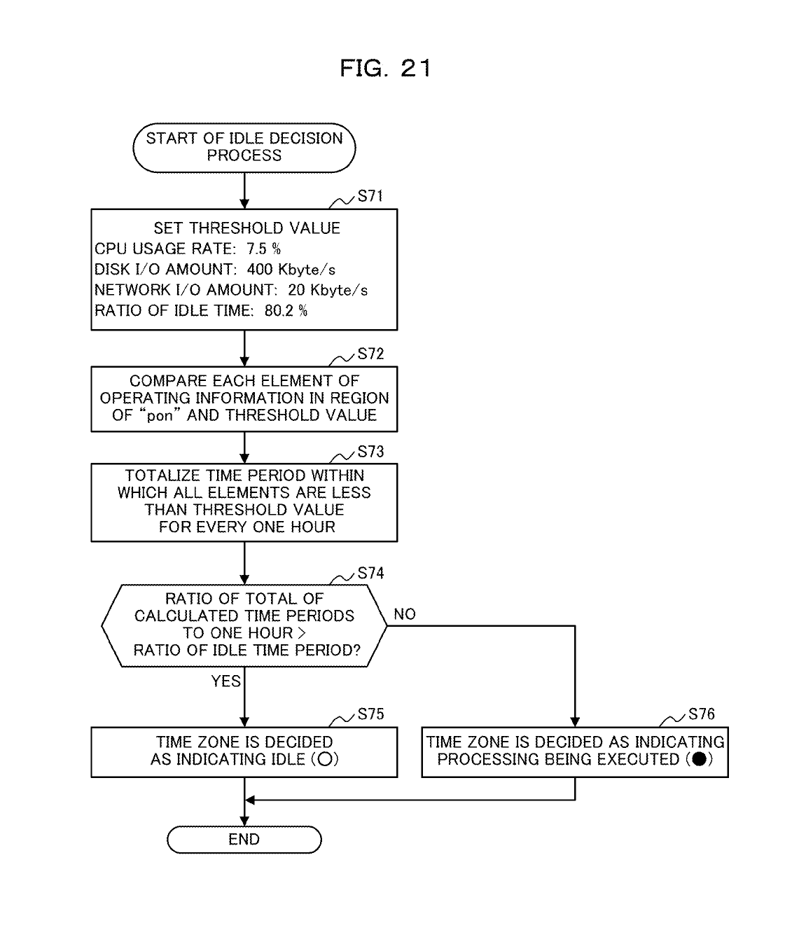

Now, an example of operation of the first integration unit 27 (detailed example at step S4 of FIG. 17) is described with reference to flow charts depicted in FIGS. 20 and 21.

As depicted in FIG. 20, the first integration unit 27 defines the variable n for identification of a virtual machine VM11 (n=1; step S51), and reads in an operation state for one hour (six operation states) in the VMn field of the operation decision list 22b (step S52). Then, the first integration unit 27 decides in order whether or not there are operation states corresponding to “down” and “pon” in the plurality of read-in operation states (steps S53 and S54).

If the plurality of read-in operation states do not include any of “down” and “pon” (No at step S53 and S54), then the first integration unit 27 decides that all of the operation states indicate “poff” and decides that the time zone indicates power OFF (-) (step S55). Then, the first integration unit 27 decides whether or not the row at present is the end of the operation decision list 22b (step S56). If the row at present is not the end (No at step S56), then the processing advances to step S52.

On the other hand, if the row at present is the end (Yes at step S56), then the first integration unit 27 increments n (n=n+1; step S57) and decides whether or not n is greater than the number of virtual machines (VMs) of the user (step S58). If n is not greater than the virtual machine (VM) number of the user (No at step S58), then the processing advances to step S52. On the other hand, If n is greater than the virtual machine (VM) number of the user (Yes at step S58), then the processing is ended.

On the other hand, if the plurality of read-in operation states include at least one “pon” at step S54 although they include no “down” (No at step S53 and Yes at step S54), then the processing advances to step S59. At step S59, the first integration unit 27 performs an idle decision process using the data in which there is “pon” from within the data for one hour, and then, the processing advances to step S56. It is to be noted that details of the process at step S59 are hereinafter described.

On the other hand, if the plurality of read-in operation states include at least one “down” at step S53 (Yes at step S53), then the first integration unit 27 decides that the time zone indicates data loss (decision impossible) (x) (step S60), and the processing advances to step S56. The process of the first integration unit 27 ends therewith. It is to be noted that the first integration unit 27 newly produces or updates the first integration list 22c in the process of the processing described above. Or, the first integration unit 27 may process the operation decision list 22b (delete part of data or the like) to produce the first integration list 22c.

Now, the idle decision process at step S59 is described.

As depicted in FIG. 21, the first integration unit 27 first sets various threshold values (step S71), and acquires values of operating information with regard to which a decision result of “pon” is obtained at step S55 of FIG. 20 from the operation data list 22a. Then, the first integration unit 27 compares the values of the elements of the acquired operating information and the corresponding threshold values with each other (step S72). It is to be noted that the process at step S71 may be executed by setting, for example, by the manager or the like, various threshold values to the storage unit 21 or the retention unit 22 in advance and reading out the threshold values by the first integration unit 27.

Then, the first integration unit 27 calculates the total of time periods within which all elements are lower than the threshold values after every one hour (step S73). Then, the first integration unit 27 decides whether or not the ratio of the calculated total time period to one hour is higher than the ratio (predetermined threshold value; here, 80.2%) of idle time (step S74).

If the ratio of the total time period is higher than the ratio of idle time (Yes at step S74), then the first integration unit 27 decides that the time zone indicates an idle state (∘) (step S75), and the processing is ended. On the other hand, if the ratio of the total time period is equal to or lower than the ratio of idle time (No at step S74), then the first integration unit 27 decides that the time zone indicates a processing execution state (•) (step S76), and then the processing is ended. The idle decision process by the first integration unit 27 ends therewith.

[3-4-4] Example of the Integration Process of the Second Integration Unit

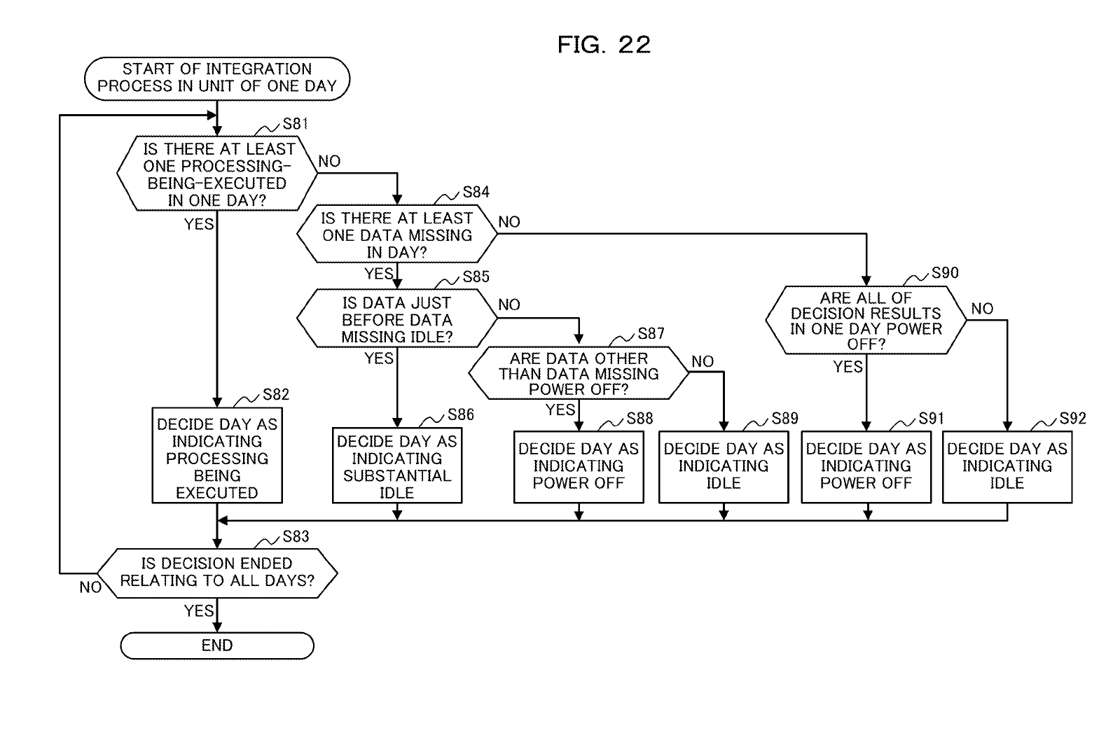

Now, an example of operation of the second integration unit 28 (detailed example at step S5 of FIG. 17) is described with reference to a flow chart depicted in FIG. 22. It is to be noted that the process of FIG. 22 is executed for each of the virtual machines VM11.

As depicted in FIG. 22, the second integration unit 28 decides whether or not the operation states for one day in the first integration list 22c of the retention unit 22 include at least one processing execution state (step S81). If a processing execution state is found (Yes at step S81), then the second integration unit 28 decides that the one day indicates a processing execution state (step S82), and decides whether or not decision is completed for all days (step S83). If the decision is not completed for all days (No at step S83), then the processing advances to step S81. On the other hand, if the decision is completed for all days (Yes at step S83), then the processing is ended.

On the other hand, if the operation states for one day include no processing execution state (No at step S81), then the second integration unit 28 decides whether or not the operation states for one day include at least one data loss (step S84). If the operation states for one day include data loss (Yes at step S84), then the second integration unit 28 decides whether or not a time zone just before that of the data loss indicates an idle state (∘) (step S85).

If the time zone just before that of the data loss indicates an idle state (Yes at step S85), then the second integration unit 28 decides that the operation state within the one day is a substantially idle state (step S86), and the processing advances to step S83.

On the other hand, if the time zone just before that of data loss does not indicate an idle state at step S85 (No at step S85), then the second integration unit 28 decides whether or not the operation situation within all of the time zones in the day other than the time zone of the data loss is a power OFF state (step S87). If the operation situation within all time zones other than the time zone of the data loss is a power OFF state (Yes at step S87), then the second integration unit 28 decides that the operation state in the day is a power OFF state (step S88), and the processing advances to step S83.

On the other hand, if the operation situation within all time zones other than the time zone of the data loss is not a power OFF state (No at step S87), then the second integration unit 28 decides that the operation situation in the day is an idle state (step S89), and the processing advances to step S83.

Further, if the operation states for one day do not indicate data loss (No at step S84), then the second integration unit 28 decides whether or not all of results of the decision within the time zones in the one day indicate a power OFF state (step S90). If all of the decision results indicate a power OFF state (Yes at step S90), then the second integration unit 28 decides that the operation situation in the one day is a power OFF state (step S91), and the processing advances to step S83.

On the other hand, if a state other than power OFF is included in the decision results within the time zones in the one day (No at step S90), then the second integration unit 28 decides that the operation situation in the day is an idle state (step S92), and the processing advances to step S83. The process of the second integration unit 28 ends therewith.

[3-5] Effect of the Embodiment

With the outputting server 2 in the embodiment described above, also where a first period within which operating information of a virtual machine VM11 is not acquired is included in a predetermined period, operation actual results of the virtual machine VM11 within the first period are estimated and outputted. In particular, the outputting server 2 can estimate the operation actual results of the virtual machine VM11 within the first period on the basis of the operating information of the management virtual machine VM15 within the first period and the operating information of the virtual machine VM11 acquired at least at one of preceding and succeeding timings to the first period. Accordingly, the operation actual results of the virtual machine VM11 within the period within which operating information is not acquired can be outputted.

While, in the technical field relating to a cloud system, operation states of a virtual machine (VM) are sometimes classified using operating information, in what circumstances operating information does not exist at a location at which operating information does not exist (whether such operating information has been lost by a user or by a failure of the management virtual machine VM15) is not available as information. Accordingly, the outputting server conventionally decides and displays an operation state only with regard to a time period within which the virtual machine (VM) operates and need not take a location at which operating information does not exist into consideration.

However, when it is attempted to visualize also a power OFF state of a virtual machine (VM) as operation actual results to a user, it is recognized that it is important to specify a factor (classify an operation state) with regard to a location at which operating information does not exist as described above although conventionally this is not recognized very much. For example, where, with regard to absence of operating information, distinction between power OFF and a failure of a management virtual machine (VM) from each other or classification of an operation state at the location, at which operating information does not exist, from data within the preceding and succeeding time zones to the location is not performed, all of the time zones within which there is no data are considered as data loss locations (refer to FIGS. 2 to 4).

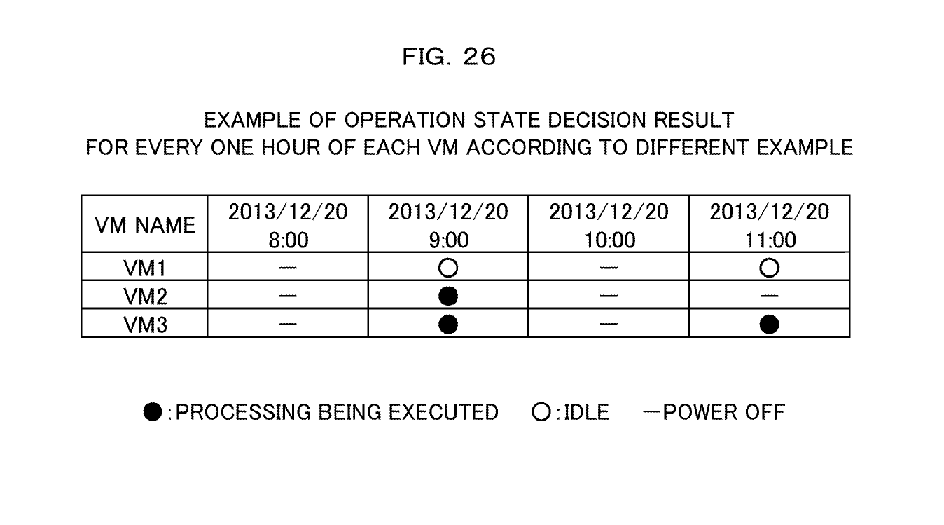

It is to be noted that, if distinction between causes of loss of operating information by power OFF control of a virtual machine (VM) by a user and a failure of the management virtual machine (VM) is not performed and it is considered that all of the time zones within which there is no data originate from power OFF of the virtual machine (VM), then a result of decision of the operation state of each virtual machine (VM) for every one hour is such as exemplified in FIG. 26. In FIG. 26, although also operating information of the virtual machine (VM) of the user is not obtained successfully because of a failure of the management virtual machine (VM), even if the virtual machine (VM) of the user is in an activated state, it is regarded that this arises from power OFF (refer to the data within 10 and 11 a.m.), and a situation different from an actual situation is presented.

Further, in order to grasp a state of power ON/OFF of a virtual machine (VM) at a time point in the past, it may be recommendable to refer to a system log of a host server of virtualization. However, where the cloud system assumed in the description of FIG. 15 is presented as an example, confirmation between dead or alive of up to 1500 virtual machines (VMs) is performed from within system logs individually existing in 30 host servers, and the processing amount is greater than that in a case in which the operation data 21a is used, and also time is used for the process.

Also it seems recommendable to perform definition of a power ON/OFF state for an expansion trap signal of the Simple Network Management Protocol (SNMP) and then perform decision of power ON, power OFF and failure occurrence through a Ping response. However, in this case, since also it is possible to limit the Ping response in order to achieve enhancement of the security on the virtual machine (VM), decision of the operation state is difficult to perform for a virtual machine (VM) to which limitation to the Ping response is applied.

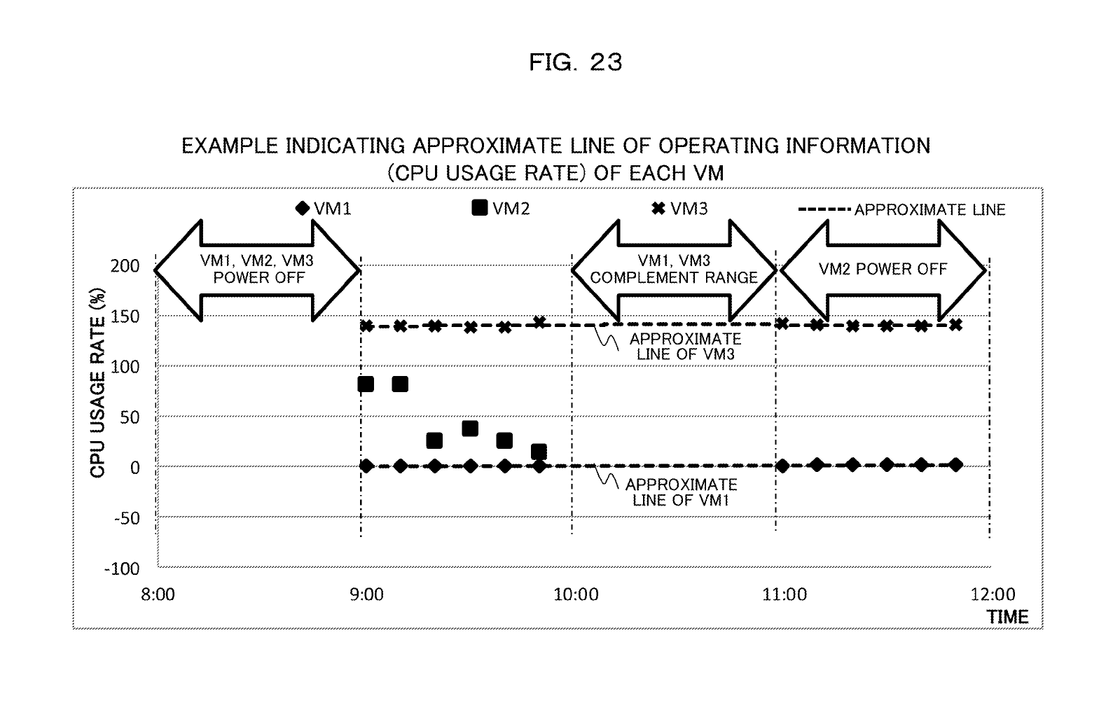

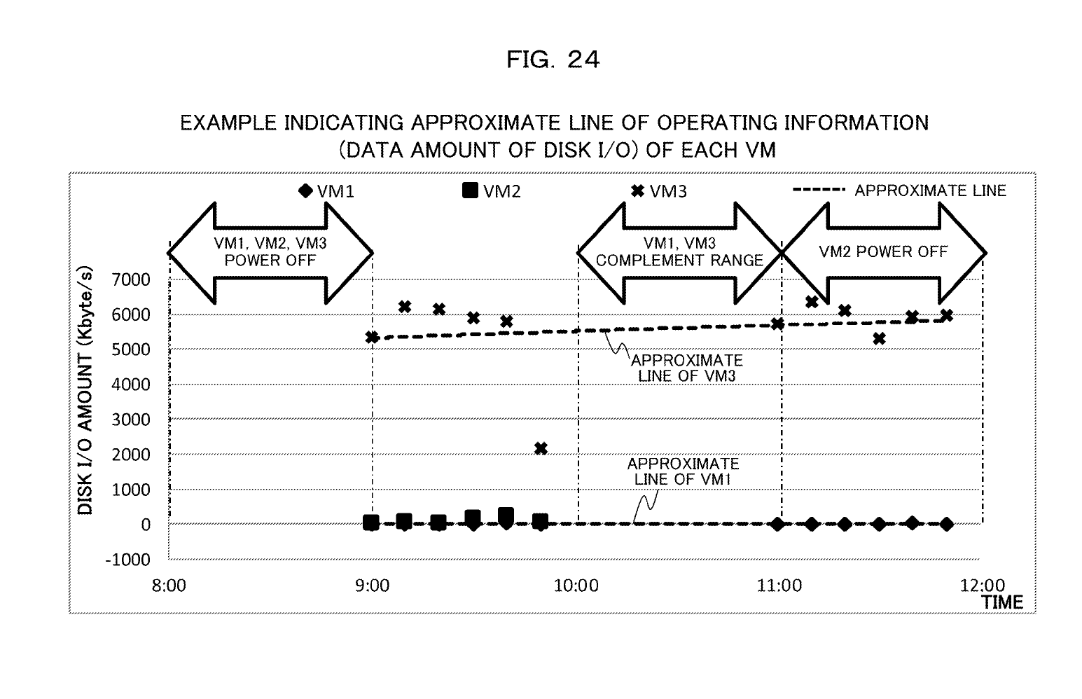

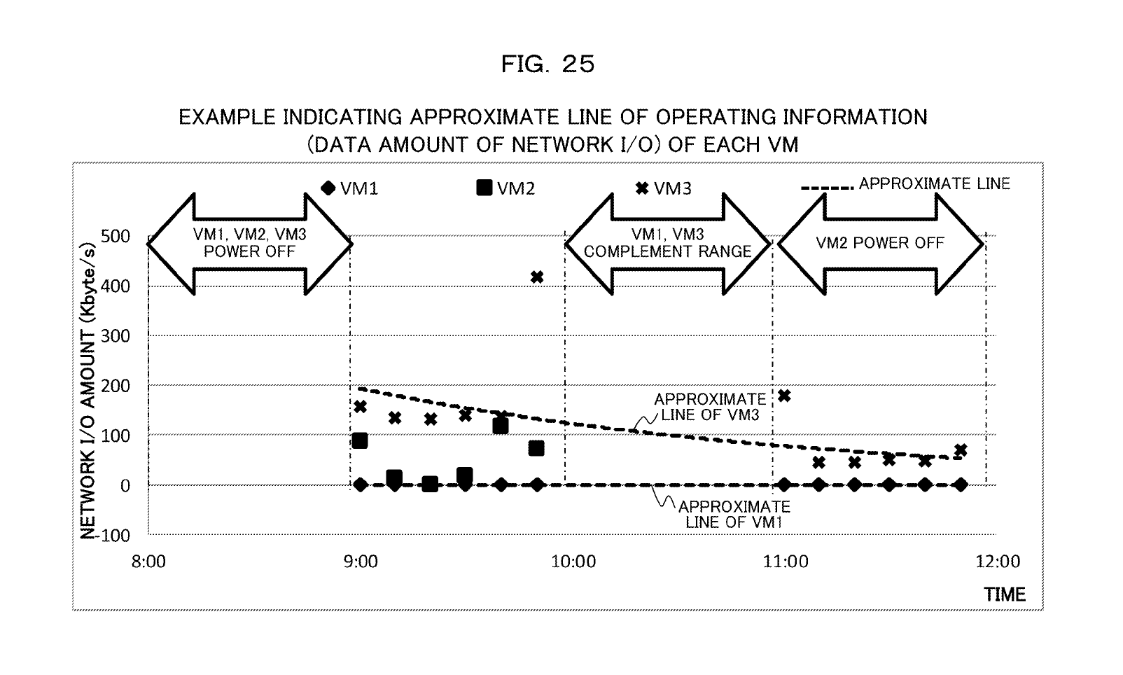

In contract to the techniques described above, with the outputting server 2, since a power OFF state of a virtual machine VM11 by the user can be easily decided, calculation of an approximate line of the operating information can be suppressed relating to the virtual machines VM1, VM2 and VM3 between 8 and 9 a.m., for example, as depicted in FIGS. 23 to 25. In this manner, with the outputting server 2, the reliability of the report of the operation result can be enhanced while the processing load is suppressed.

[4] Modifications

While the embodiment is described above in which the outputting server 2 decides an operation state of a virtual machine VM11 in a unit of one hour by the first integration unit 27 and the second integration unit 28 decides an operation state of the virtual machine VM11 in a unit of one day using a result of the decision by the first integration unit 27, the technology disclosed herein is not limited to this.

[4-1] First Modification

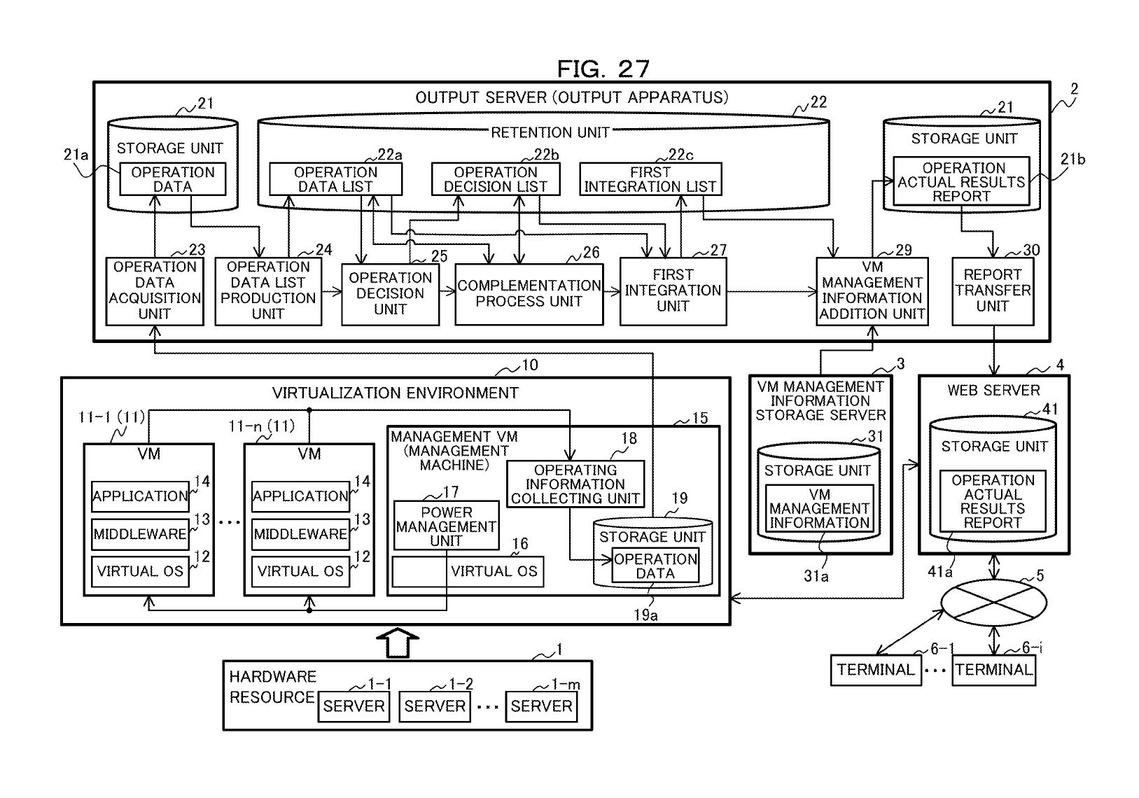

For example, where the outputting server 2 outputs the operation actual results report 21b when an operation state of the virtual machine VM11 is decided in a unit of one hour, the outputting server 2 can be configured in such a manner as exemplified in FIG. 27.

As depicted in FIG. 27, the outputting server 2 in the system according to a first modification newly includes a function as a complementation process unit 26 and can omit the function as the second integration unit 28.

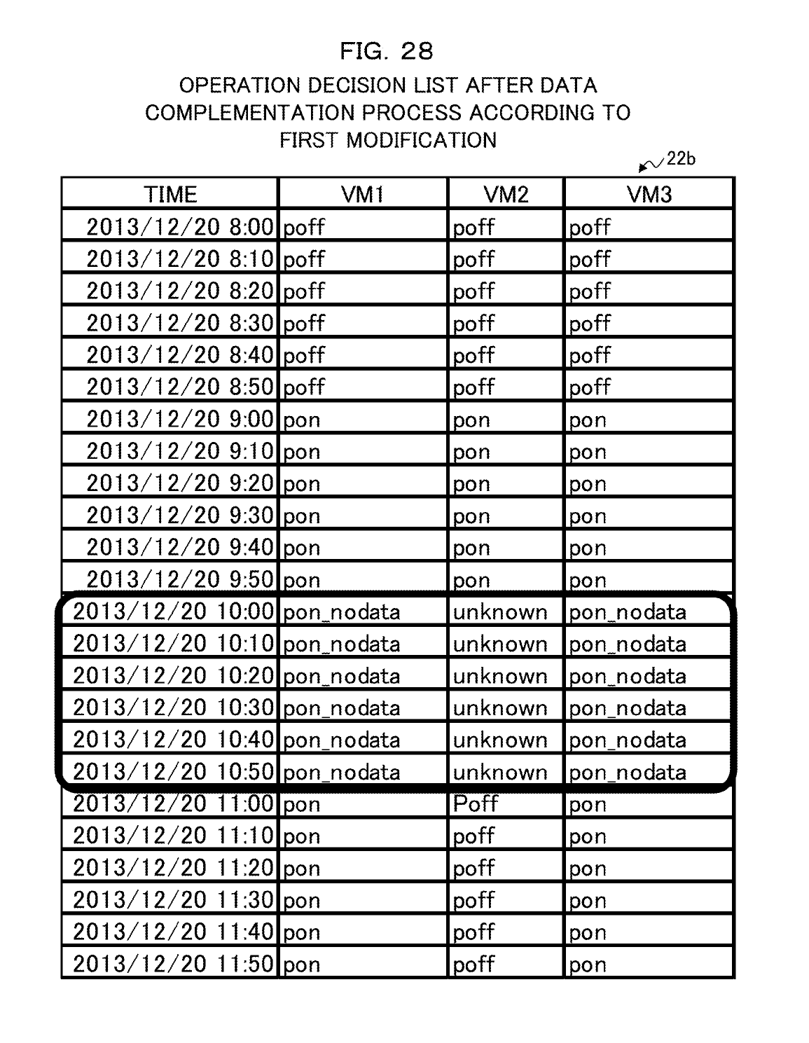

The complementation process unit 26 can perform a complementation process for a location for which data complementation can be performed from among locations with regard to which it is decided by the operation decision unit 25 that data loss is caused by a failure of the management virtual machine VM15 (from among locations of the operation decision list 22b at which “down” is set). For example, the complementation process unit 26 performs the complementation process for a location (operation state) for which data complementation can be performed on the basis of the data within the preceding and succeeding time zones to the time zone in which “down” is set in the operation decision list 22b thereby to update the operation decision list 22b as depicted in FIG. 28. It is to be noted that the complementation process unit 26 does not perform the complementation process for a location at which data complementation is impossible and decides the location as a decision impossible location (sets “unknown”).

For example, the complementation process unit 26 refers to the operation decision list 22b to read in one by one row of each of the virtual machines VM11, and classifies locations to which “down” is set into the following four cases and then updates the operation decision list 22b.

(i) Where the preceding and succeeding time zones to the location to which “down” is set indicate a power ON state:

Since an operation of the management virtual machine VM15 is disabled, a power operation for the virtual machine VM11 is impossible within a time zone of data loss, and therefore, the complementation process unit 26 decides that the location to which “down” is set has indicated a power ON state. Then, the complementation process unit 26 sets and rewrites “pon_nodata” indicating estimation as a power ON state to and into the location to which “down” is set.

(ii) Where the preceding and succeeding time zones to the location to which “down” is set indicate a power OFF state:

Since an operation of the management virtual machine VM15 is disabled and a power operation for the virtual machine VM11 is impossible within a time zone of data loss, the complementation process unit 26 decides that the location to which “down” is set has indicated a power OFF state. Then, the complementation process unit 26 sets and rewrites “poff” indicating estimation as a power OFF state to the location to which “down” is set.

(iii) Where the preceding time zone to the location to which “down” is set indicates a power ON state while the succeeding time zone to the location to which “down” is set indicates a power OFF state:

Despite that a power operation by the management virtual machine VM15 within a time zone of data loss is disabled, the virtual machine VM11 is placed into a power OFF state at some timing within the time zone of data loss. In this case, the complementation process unit 26 does not perform decision of an operation state (power ON state/power OFF state) at the location to which “down” is set. Then, the complementation process unit 26 sets and rewrites “unknown” indicating that decision of an operation state is not performed to and into the location to which “down” is set.

(iv) Where the preceding time zone to the location to which “down” is set indicates a power OFF state while the succeeding time zone to the location to which “down” is set indicates a power ON state:

Despite that a power operation by the management virtual machine VM15 within the time zone of data loss is disabled, the virtual machine VM11 is placed into a power ON state at some timing within the time zone of data loss. Also in this case, the complementation process unit 26 does not perform decision of an operation state (power ON state/power OFF state) at the location to which “down” is set. Then, the complementation process unit 26 sets and rewrites “unknown” indicating that decision of an operation state is not performed to and into the location to which “down” is set.

As an example, a case is described in which the complementation process unit 26 performs a complementation process for the virtual machine VM1 in the operation decision list 22b depicted in FIG. 9. The complementation process unit 26 reads in the field of the virtual machine VM1 in the operation decision list one by one row. Since the time zone at 8:00 indicates “poff”, the complementation process unit 26 decides Before as “Before=poff” and successively reads the field of the virtual machine VM1 on by one row down to a row in which “down” is written. Since the time zone at 10:00 indicates “down”, the complementation process unit 26 decides Before as “Before=pon” and successively reads the field of the virtual machine VM1 down to a row in which any other state than “down” is written. Since the time zone at 11:00 indicates “pon”, the complementation process unit 26 decides After as “After=pon”.

Since “Before=pon” and “After=pon” are satisfied within the time zones at 10:00 to 10:50 which indicate “down”, the complementation process unit 26 rewrites the data within the time zones at 10:00 to 10:50 into “pon_nodata” in accordance with the condition (i) described above. It is to be noted that, although the complementation process unit 26 successively reads the field of the virtual machine VM1 one by one row from 10:00 to 10:50 similarly, since the reading reaches the end of the list while “down” is not found, the complementation process for a data loss location of the virtual machine VM1 is ended. Further, as regards the example of FIG. 9, the complementation process unit 26 performs, for the virtual machines VM2 and VM3, decision and classification regarding the necessity for complementation of an operation state within a time zone of “down” on the basis of operation states set within the preceding and succeeding time zones to the time zone of “down”, in a similar manner as in the case of the virtual machine VM1.

In accordance with such decision criteria as given by the conditions (i) to (iv) hereinabove, the complementation process unit 26 performs update of the operation decision list 22b as depicted in FIG. 28. For example, within time zones (10:00 to 10:50) indicated by a thick frame in FIG. 28, since the preceding and succeeding time zones to a time zone of “down” with regard to the virtual machines VM1 and VM3 indicate “pon”, the complementation process unit 26 estimates that the virtual machines VM1 and VM3 are in a power ON state and sets “pon_nodata” to the virtual machines VM1 and VM3. Further, with regard to the virtual machine VM2, although the preceding time zone indicates “pon”, since the succeeding time zone to the time zone of “down” indicates “poff”, the complementation process unit 26 does not perform decision of an operation state and sets “unknown” to the virtual machine VM2 within the time zones.

By the classification by the complementation process unit 26 described above, as regards a location corresponding to the case of (1) above, although an operation situation is not acquired originally, it is decided that the location indicates a power ON state and complementation of data is performed. It is to be noted that, with regard to a location corresponding to the case of (ii) above, since it is decided that the location indicates a power OFF state, complementation of data is not required. Further, with regard to locations corresponding to the cases of (iii) and (iv) above, since power ON/OFF is not decided, complementation of data is not required.

In this manner, taking notice of the fact that an operation for power ON/OFF is performed through the management virtual machine VM15 in the cloud system, the complementation process unit 26 evaluates operation states in the preceding and succeeding time zones to a time zone within which it is decided that the management virtual machine VM15 suffers from a failure. Then, the complementation process unit 26 can specify (estimate) a time zone within which an operation state within a “time zone within which there is no data” is to be complemented and another time zone within which an operation state is not complemented in the operation decision list 22b. Consequently, the complementation process unit 26 can suitably decide whether or not complementation of an operation state is to be performed and classification of an operation state can be performed accurately.

It is to be noted that, while it is described that the complementation process unit 26 in the first modification performs the process described above on the basis of operation states in the preceding and succeeding time zones to a time zone of “down”, the complementation process unit 26 is not limited to this. The complementation process unit 26 may perform the process described above on the basis of at least one of operation states in the preceding and succeeding time zones to the time zone of “down”.

In particular, it can be considered that the complementation process unit 26 estimates an operation state of a virtual machine VM11 within a second period within which operating information of the management virtual machine VM15 is not acquired on the basis of operating information of the virtual machine VM11 acquired at least at one of preceding and succeeding timings to the second period.

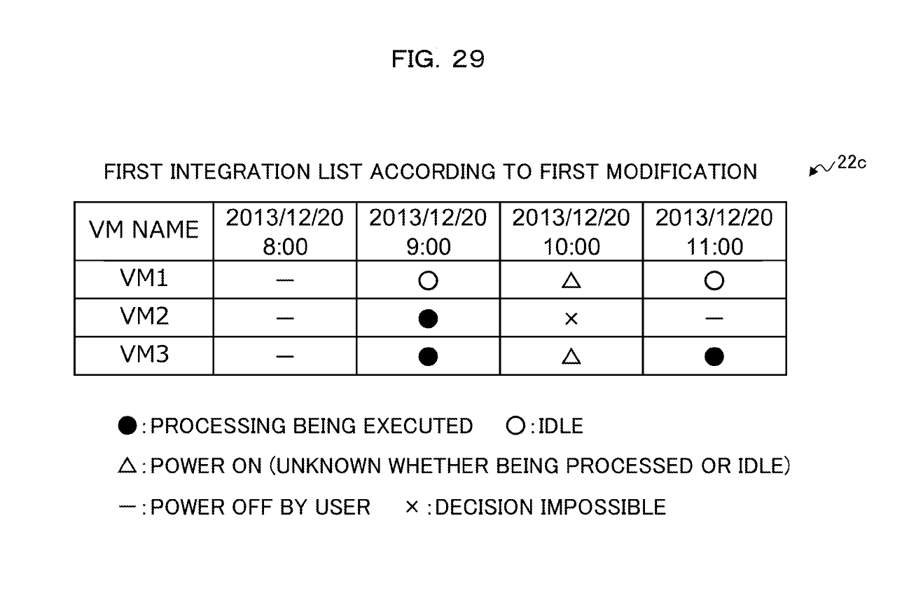

The first integration unit 27 in the first embodiment performs the process for integrating operation states within a plurality of time zones of the virtual machines VM11 in the operation decision list 22b for which the complementation process has been performed by the complementation process unit 26 to produce a first integration list 22c exemplified in FIG. 29 and stores the produced list into the retention unit 22.

For example, the first integration unit 27 reads out a plurality of (in this case, six) operation states in an integration unit (unit of one hour) from the operation decision list 22b with regard to each virtual machine VM11, and decides an operation state within the integrated time zone in accordance with conditions given below which are different from those of the embodiment.

(I′) When the plurality of read out operation states include at least one “unknown”: it is decided that deciding the operation state of the integrated time zone is impossible.

(II′) When the plurality of read out operation states do not include “unknown” but include at least one “pon_nodata”: it is decided that the integrated time zone indicates a power ON state.

(III) When the plurality of read out operation states do not include any of “unknown” and “pon_nodata” but include at least one “pon”: an idle decision process is performed using operating information in the time zone (unit of 10 minutes) to which “pon” is set.

(IV′) When none of the conditions (I) to (III) above is satisfied: it is decided that the integrated time zone indicates a power OFF state.

In the following, in order to avoid overlapping description, a case is described in which the first integration unit 27 performs integration of operation states between 10 and 11 a.m. in the operation decision list 22b depicted in FIG. 28. It is to be noted that the first integration unit 27 actually performs integration of operation states for every one hour (between 8 and 9 a.m., between 9 and 10 a.m., between 10 and 11 a.m. and between 11 and 12 a.m.) similarly as in the embodiment.

For example, since “unknown” is set to all of six time zones (unit of 10 minutes) in the time zone between and 11 a.m. of the virtual machine VM2, the first integration unit 27 decides in accordance with the condition (I′) described above that, within the integrated time zone, deciding the operation state is impossible. Then, as depicted in FIG. 29, the first integration unit 27 sets a cross mark (x) indicating impossibility of decision to the time zone between 10 and 11 a.m. of the virtual machine VM2.

Further, the first integration unit 27 decides that, although no “unknown” is set to the time zone between 10 and 11 a.m. of the virtual machines VM1 and VM3, “pon_nodata” is set to all of the six time zones (unit of 10 minutes). Accordingly, the first integration unit 27 decides on the basis of the condition (II′) given above that the time zones between 10 and 11 a.m. of the virtual machines VM1 and VM3 indicate a power ON state, and sets a triangle (Δ) indicating a power ON state to the time zones between 10 and 11 a.m. of the virtual machines VM1 and VM3 as depicted in FIG. 29.

It is to be noted that symbols including a filled circle (•), an open circle (∘), a hyphen (-), a triangle (Δ) and a cross mark (x) indicating operation states set in the first integration list 22c of FIG. 29 are exemplary and are not limited to them. The operation states can be represented by various representation methods such as, for example, a binary number of 3 bits.

The VM management information addition unit 29 merges the information of the first integration list 22c produced in such a manner as described above and the VM management information 31a with each other to produce an operation actual results report 21b in a unit of one hour and stores the produced report into the storage unit 21. Then, the operation actual results report 21b in a unit of one hour is transferred to the Web server 4 by the report transfer unit 30 and is provided as an operation actual results report 41a to the terminals 6-1 to 6-i by the Web server 4. It is to be noted that, for the operation actual results report 41b, data conversion may be performed by the outputting server 2 (first integration unit 27, VM management information addition unit 29, report transfer unit 30 or the like), or by the Web server 4 or the like.

In this manner, the operation decision unit 25, complementation process unit 26 and first integration unit 27 in the first modification can be regarded as an example of an estimation unit.

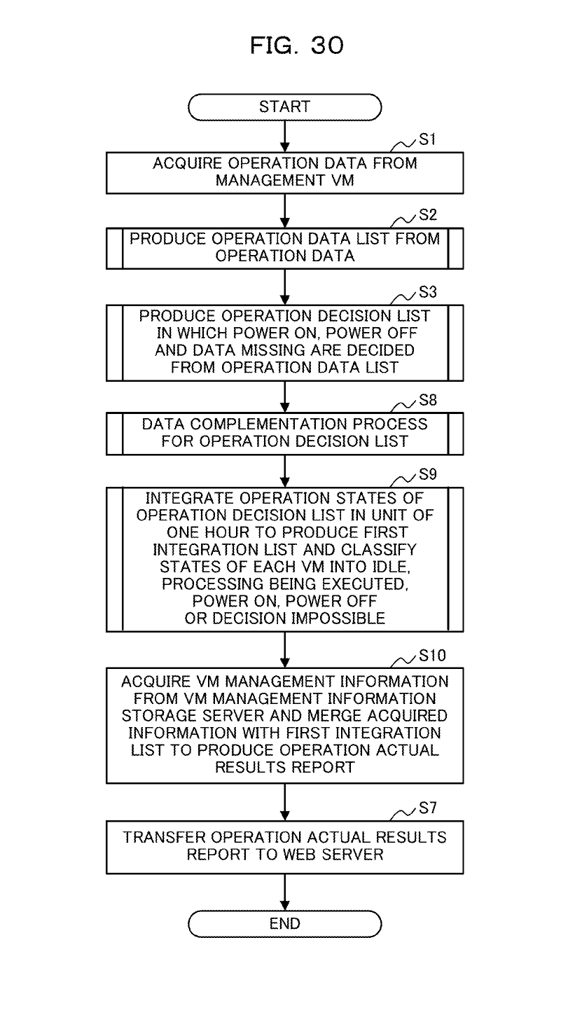

Now, an example of operation of the outputting server 2 according to the first modification configured in such a manner as described above is described with reference to FIGS. 30 to 32. It is to be noted that, in the following description, overlapping description of a process same as or substantially same as that described hereinabove is omitted.

First, operation of a production process of an operation actual results report 21b by the outputting server 2 in the first modification is described with reference to a flow chart depicted in FIG. 30.

As depicted in FIG. 30, in the first modification, processes at steps S8 to S10 are executed in place of the processes at steps S4 to S6 depicted in FIG. 17. At step S8, the complementation process unit 26 decides whether or not data complementation is to be performed for the operation decision list 22b, and the complementation process of data is performed for an operation state with regard to which it is decided that the data complementation is to be performed.

Then, the first integration unit 27 integrates the operation states of the operation decision list 22b in a unit of one hour to produce a first integration list 22c and stores the produced first integration list 22c into the retention unit 22. At this time, the first integration unit 27 classifies the operation states of the virtual machines VM11 into idle, processing being executed, power ON, power OFF and decision impossible (step S9).

Then, the VM management information addition unit 29 acquires the VM management information 31a from the VM management information storage server 3. Then, the VM management information addition unit 29 merges the VM management information 31a with the first integration list 22c to produce an operation actual results report 21b in a unit of one hour and stores the produced operation actual results report 21b into the storage unit 21 (step S10). Then, the processing advances to step S7.

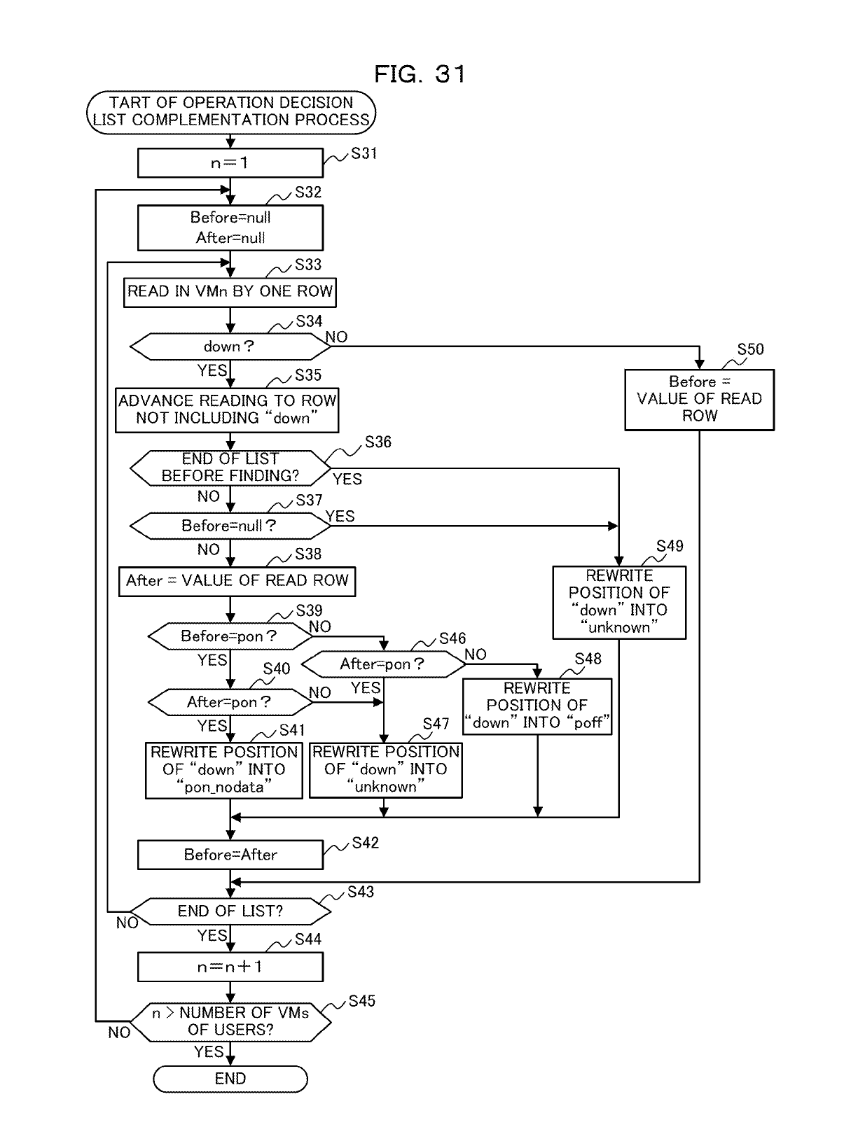

Now, an example of operation of the complementation process unit 26 (detailed example at step S8 of FIG. 30) is described with reference to a flow chart depicted in FIG. 31.

As depicted in FIG. 31, the complementation process unit 26 defines a variable n for identification of a virtual machine VM11 (n=1; step S31) and defines variables “Before” and “After” for storing values of operation states within preceding and succeeding time zones to a row to be read in (Before=null, After=null; step S32). Then, the complementation process unit 26 reads in one row of the virtual machine VMn in the operation decision list 22b (step S33), and decides whether or not the value of the operation state indicates “down” (step S34).

If the value of the operation state indicates “down” (Yes at step S34), then the complementation process unit 26 reads the virtual machine VMn in the operation decision list 22b to a row that indicates a state other than “down” (step S35). If the reading reaches the end of the operation decision list 22b before a row that indicates a state other than “down” is found (step S36, Yes at step S36) or if the operation state is “Before=null” when a row that indicates a state other than “down” is found (step S37, Yes at step S37), then the processing advances to step S49.

On the other hand, if a row that indicates a state other than “down” is found (No at step S36) and the state at this time is not “Before=null” (No at step S37), then the complementation process unit 26 sets a value of the row read in at this time to “After” (step S38).

Then, the complementation process unit 26 decides whether or not the state indicates “Before=pon” (step S39), and, if the state indicates “Before=pon” (Yes at step S39), then the complementation process unit 26 decides whether or not the state indicates “After=pon” (step S40). If the state indicates “After=pon” (Yes at step S40), then since the preceding and succeeding time zones to “down” indicate “pon”, the complementation process unit 26 rewrites the value at the position of “down” read till then in the operation decision list 22b into “pon_nodata” (step S41).

Then, the complementation process unit 26 sets the value of “After” to “Before” (step S42), and decides whether or not the row at present is the end of the operation decision list 22b (step S43). If the row at present is not the end (No at step S43), then the processing advances to step S33. On the other hand, if the row at present is the end (Yes at step S43), then the complementation process unit 26 increments the variable n (n=n+1; step S44), and decides whether or not the variable n is greater than the VM number of the user (step S45).

If the variable n is not greater than the number of virtual machines (VM) of the user (No at step S45), then the processing advances to step S32. On the other hand, if the variable n is greater than the number of virtual machines (VM) of the user (Yes at step S45), then the processing is ended.

On the other hand, if the state is not “After=pon” at step S40 (No at step S40), then the operation states of the virtual machine VMn within preceding and succeeding time zones to “down” (power is switched from ON to OFF within the time zone of “down”) are different from each other. Therefore, the complementation process unit 26 rewrites the value at the positions of “down” read till then in the operation decision unit 22b into “unknown” (step S47), and the processing advances to step S42.

Further, if the state is not “Before=pon” at step S39 (No at step S39), then the complementation process unit 26 decides whether or not the state is “After=pon” (step S46). If the state is “After=pon” (Yes at step S46), then the operation states of the virtual machine VMn within the preceding and succeeding time zones to “down” (power is switched from OFF to ON within the time zone of “down”) are different from each other. Also in this case, the processing advances to step S42 through step S47.

On the other hand, if the state is not “After=pon” at step S46 (No at step S46), then the preceding and succeeding time zones to “down” indicate “poff”. Accordingly, the complementation process unit 26 rewrites the value at the positions of “down” read till then in the operation decision list 22b into “poff” (step S48), and the processing advances to step S42.

It is to be noted that, at step S49, the complementation process unit 26 rewrites the value at the positions of “down” read till then in the operation decision list 22b into “unknown” similarly as at step S47, and the processing advances to step S42. Here, the process at step S49 is executed when the Yes is taken at step S36 or S37 as described above. Further, the reason why the value at the positions of “down” is rewritten into “unknown” at step S49 is that, when the Yes is taken at step S36, “down” is set down to the end of the operation decision list 22b and the operation state after the time zone of “down” is unknown. Further, when the Yes is taken at step S37, “down” is set to positions from the start of the operation decision list 22b and the operation state before the time zone of “down” is unknown.

Further, when the value of the operation state does not indicate “down” at step S34 (No at step S34), the complementation process unit 26 sets the value of the row read in at this time to “Before” (step S50), and the processing advances to step S43. The process of the complementation process unit 26 ends therewith.

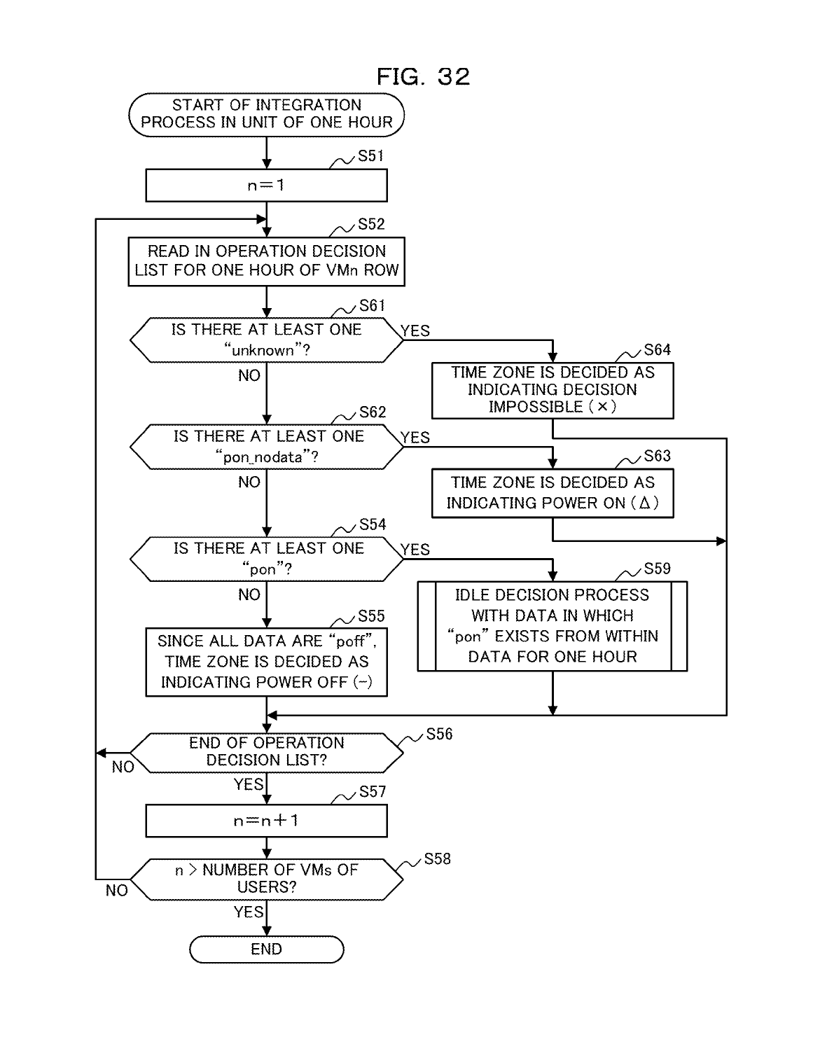

Now, an example of operation (detailed example at step S9 of FIG. 30) of the first integration unit 27 according to the first modification is described with reference to a flow chart depicted in FIG. 32.

As depicted in FIG. 32, in the first modification, processes at steps S61 and S62 and steps S63 and S64 are executed in place of the processes at steps S53 and S60 depicted in FIG. 20. The first integration unit 27 successively decides whether or not the plurality of operation states read in at step S52 include operation states corresponding to “unknown”, “pon_nodata” and “pon” (steps S61, S62 and S54).

If the plurality of read-in operation states include none of “unknown”, “pon_nodata” and “pon” (No at steps S61, S62 and S54), then the processing advances to step S55. However, if the plurality of read-in operation states include none of “unknown” and “pon_nodata” but include at least one “pon” (No at steps S61 and S62 and Yes at step S54), then the processing advances to step S59.

If the plurality of read-in operation states include no “unknown” but include at least one “pon_nodata” (No at step S61 and Yes at step S62), then the processing advances to step S63. At step S63, the first integration unit 27 decides that the state within the time zone is power ON (Δ), and the processing advances to step S56.

On the other hand, if the plurality of read-in operation states include at least one “unknown” at step S61 (Yes at step S61), then the first integration unit 27 decides that the state within the time zone is decision impossible (x) (step S64), and the processing advances to step S56.

With the first modification, the function of the second integration unit 28 can be omitted where a unit of totalization of the operation actual results report 21b is equal to or less than a predetermined number of times (for example, 10 times or the like; in the description above, 6 times) the collection unit of the operation data 21a (operation information). Accordingly, the process load to the outputting server 2 can be suppressed and the operation actual results report 21b can be easily produced.

Further, since the first integration unit 27 can decide an operation state on the basis of the detailed operation data list 22a complemented by the complementation process unit 26, the accuracy of the operation actual results report 21b can be enhanced further.

[4-2] Second Modification

It is described above that, when a plurality of read-out operation states include at least one “pon” (power ON state) in the condition (III′) described above, the first integration unit 27 in the first modification performs an idle decision process to decide whether the operation state within an integrated time zone is a processing execution state or an idle state.

In a second modification, the first integration unit (integration unit) 27 may perform the idle decision process also where the plurality of read-in operation states include at least one “pon_nodata” (power ON state) in the condition (II′) described above.

However, while the idle decision process uses the operation data list 22a (operation information) within a time zone for which the process is to be performed, operating information is in the first place lost at a location (time zone) of “pon_nodata”. Therefore, the complementation process unit 26 in the second modification can calculate approximate lines depicted in FIGS. 23 to 25 on the basis of the operation data list 22a and estimate (complement) operating information at a location of “pon_nodata”. It is to be noted that, as a calculation method of an approximate line by the complementation process unit 26, various known methods such as a least squares method can be used, and therefore, detailed description of the method is omitted.

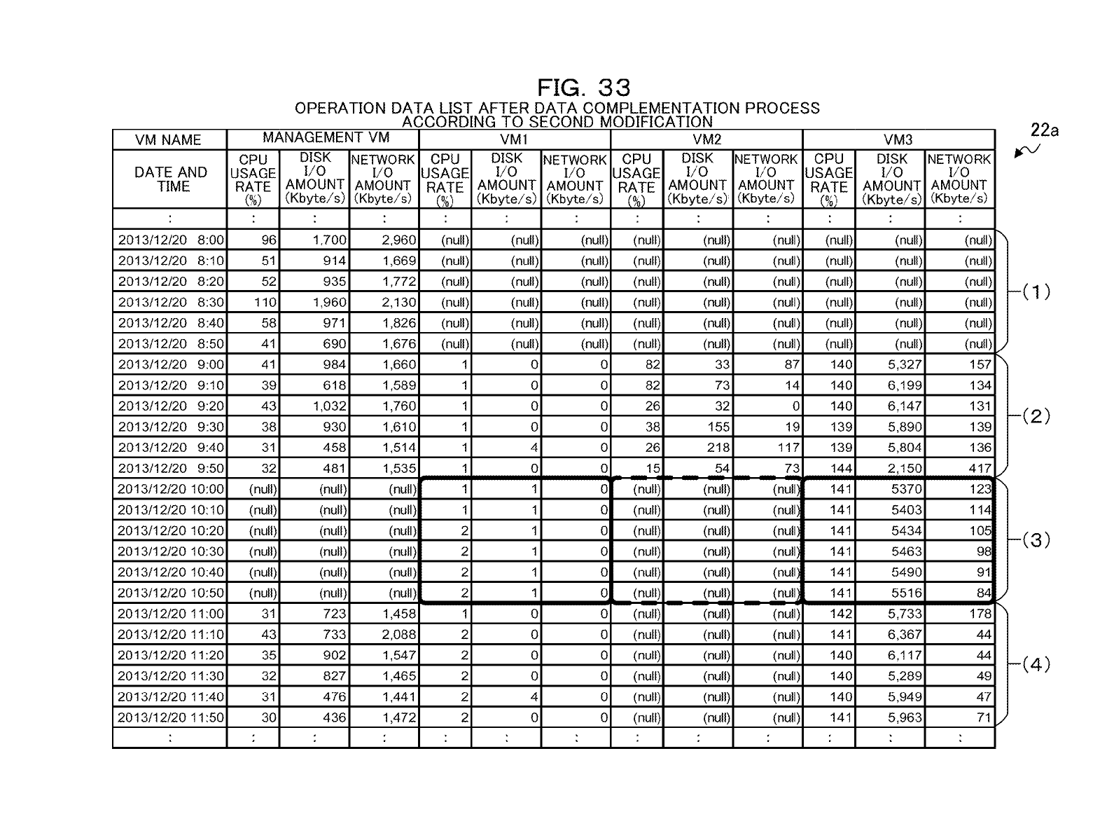

Then, with regard to the virtual machines VM1 and VM3 within the time zones between 10 and 11 a.m. (refer to (3) of FIG. 33) as indicated by a thick frame in FIG. 33, the complementation process unit 26 performs complementation for a data loss location caused by a failure of the management virtual machine VM15 on the basis of operating information within at least one of the preceding and succeeding time zones to the time zone between 10 and 11 a.m. It is to be noted that, as indicated by a broken line in FIG. 33, since the state of the virtual machine VM2 between 10 and 11 a.m. is decided as decision impossible by the operation decision unit 25, the complementation process unit 26 may omit to perform complementation for a data loss location within the time zone.

The first integration unit 27 in the second modification can perform the idle decision process within a time zone of “pon_nodata” using the operation data list 22a in which operating information is complemented by the complementation process unit 26 in such a manner as described above.

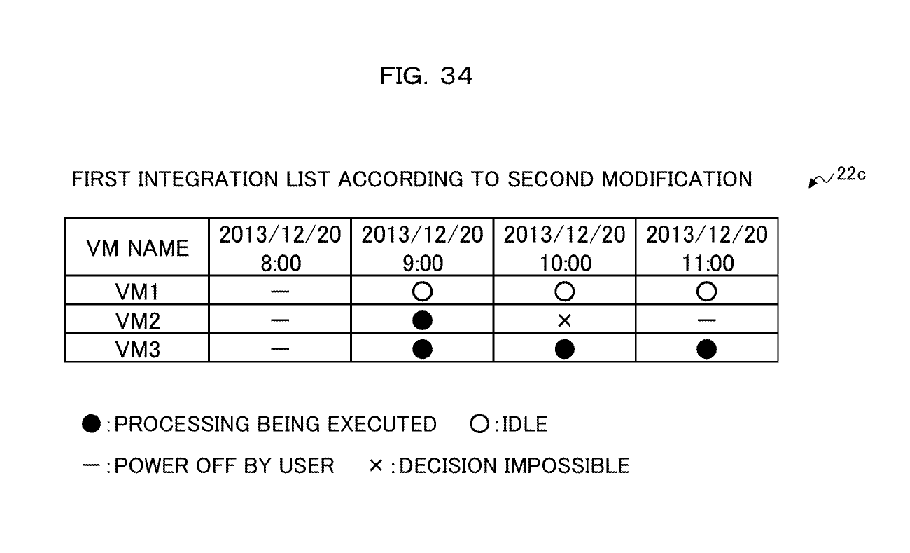

Consequently, as depicted in FIG. 34, the first integration unit 27 can decide, as regards the operation states of the virtual machines VM1 and VM3 within the time zone between 10 and 11 a.m. within which it is unknown whether the state is a processing execution state or an idle state in FIG. 29, that the virtual machine VM1 is in an idle state and the virtual machine VM3 is in a processing execution state.

It is to be noted that the first integration unit 27 in the second modification may otherwise decide whether the state is a processing execution state or an idle state in the following manner without performing the idle decision process within a time zone of “pon_nodata”. For example, the first integration unit 27 may decide the operation state within a time zone of “pon_nodata” on the basis of the operation states within the preceding and succeeding time zones of one hour to a time zone within which it is unknown whether the state is a processing execution state or an idle state. It is to be noted that, in this case, the function of the complementation process unit 26 in the second modification described above can be omitted. In the example of FIG. 34, since the state within both of the time zones of the virtual machine VM1 between 9 and 10 a.m. and between 11 and 12 a.m. is an idle state, the first integration unit 27 may decide that also the state within the time zone between 10 and 11 a.m. within which data is lost is an idle state. Further, since the state within both of the time zones of the virtual machine VM3 between 9 and 10 a.m. and between 11 and 12 a.m. is a processing execution state, the first integration unit 27 may decide that also the state within the time zone between 10 and 11 a.m. within which data is lost is a processing execution state.

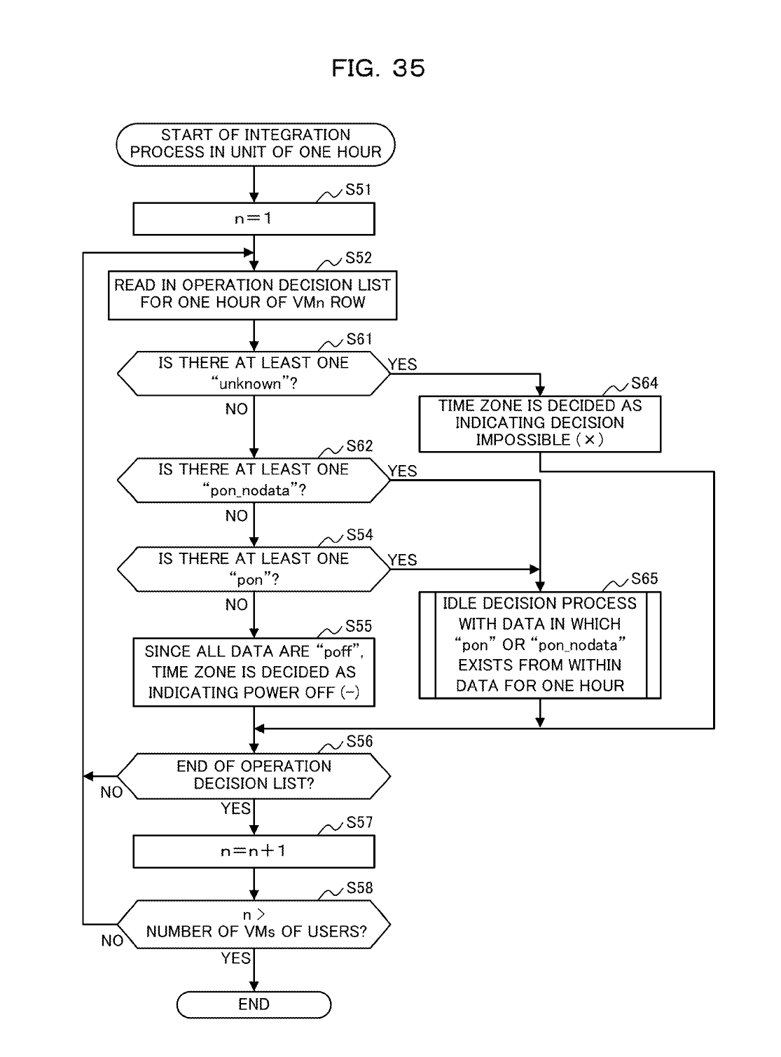

Now, an example of operation (detailed example at step S9 of FIG. 30) of the first integration unit 27 in the second modification configured in such a manner as described above is described with reference to a flow chart depicted in FIG. 35. It is to be noted that, in the following description, overlapping description of a process same as or substantially same as that described above is omitted.

As depicted in FIG. 35, in the second modification, the process at step S63 depicted in FIG. 32 is omitted, and a process at step S65 is executed in place of the process at step S59. If, at step S54, the plurality of read-in operation states include none of “unknown” and “pon_nodata” but include at least one “pon” (No at steps S61 and S62 and Yes at step S54), the processing advances to step S65.

Further, also if the plurality of read-in operation states include no “unknown” but include at least one “pon_nodata” at step S62 (No at step S61 and Yes at step S62), then the processing advances to step S65. At step S65, the first integration unit 27 performs the idle decision process using data that includes “pon_nodata” or “pon” from within data for one hour, and the processing advances to step S56.

It is to be noted that, in the idle decision process at step S65, a process basically similar to that depicted in FIG. 21 may be performed. However, at step S72 of FIG. 21, the first integration unit 27 acquires values of operating information decided as “pon_nodata” or “pon” at step S62 or S54 of FIG. 35 from the operation data list 22a. Then, the first integration unit 27 compares the acquired values of the elements of the operating information with corresponding threshold values.

As described above, with the second modification, not only an effect similar to that achieved by the first modification can be achieved but also operation states of the virtual machines VM11 included in the operation actual results report 21b in a unit of one hour can be decided more correctly than the first modification as depicted in FIG. 34.

[5] Example of the Hardware Configuration

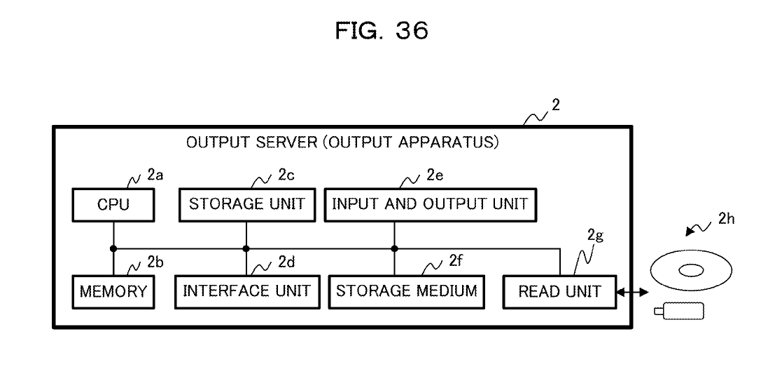

As depicted in FIG. 36, the outputting server 2 according to any of the embodiment and the first and second modifications can include a CPU 2a, a memory 2b, a storage unit 2c, an interface unit 2d, an input and output unit 2e, a record medium 2f and a reading unit 2g.

The CPU 2a is an example of an arithmetic processing unit (processor) that performs various controls and arithmetic operations. The CPU 2a is coupled with the corresponding blocks 2b to 2g, and can execute a program stored in the memory 2a, the storage unit 2c, the record medium 2f or 2h, a Read Only Memory (ROM) not depicted or the like such that various functions are implemented. For example, by executing an outputting program stored in the memory 2b, the CPU 2a can implement functions of the blocks 23 to 30 of the outputting server 2 (refer to FIGS. 6 and 27).

The memory 2b is a storage apparatus for storing various data or programs therein. The CPU 2a stores and develops data or a program into and in the memory 2b when the program is to be executed. The memory 2b can store the outputting program described above therein. It is to be noted that, as the memory 2b, a volatile memory such as, for example, a Random Access Memory (RAM) is available. The storage unit 2c is hardware for storing various data or programs therein. As the storage unit 2c, various apparatus such as, for example, a magnetic disk apparatus such as an HDD, a semiconductor drive apparatus such as an SSD and a nonvolatile memory such as a flash memory are available. It is to be noted that the storage unit 21 and the retention unit 22 depicted in FIGS. 6 and 27 may be implemented from the storage unit 2c and the memory 2b, respectively.

The interface unit 2d performs control of coupling and communication with a network (not depicted) or some other information processing apparatus by wire connection or wireless connection and so forth. As the interface unit 2d, for example, an adapter that complies with a Local Area Network (LAN), a Fiber Channel (FC), InfiniBand or the like is available. The input and output unit 2e can include at least one of an input apparatus such as a mouse or a keyboard and an output apparatus such as a display unit or a printer. For example, the input apparatus may be used for processes such as various kinds of setting to the outputting server 2 and inputting of data by a manager or the like, and the output apparatus may be used for outputting of an operation state, a result of a process (operation actual results report 21b) or the like by the outputting server 2.

The record medium 2f is a storage apparatus such as, for example, a flash memory or a ROM and can record various data or programs therein. The read unit 2g is an apparatus for reading out data or a program recorded in a computer-readable record medium 2h. In at least one of the record media 2f and 2h, an outputting program for implementing all or part of various functions of the outputting server 2 in the embodiment may be stored. For example, the CPU 2a may develop and execute an outputting program read out from the record medium 2f or an outputting program read out from the record medium 2h through the read unit 2g into a storage apparatus such as the memory 2b.

It is to be noted that, as the record medium 2h, for example, an optical disk such as a flexible disk, a Compact Disk (CD), a Digital Versatile Disc (DVD), a Blu-Ray disk and a flash memory such as a Universal Serial Bus (USB) memory or an SD card are available. It is to be noted that, as a CD, a CD-ROM, a CD-R (CD-Recordable), a CD-RW (CD-Rewritable) or the like is available. Further, as a DVD, a DVD-ROM, a DVD-RAM, a DVD-R, a DVD-RW, a DVD+R, a DVD+RW or the like is available.

The blocks 2a to 2g described above are coupled for communication with each other through a bus. Further, the hardware configuration described above of the outputting server 2 is exemplary. Accordingly, increase or decrease (for example, addition or omission of an arbitrary block), division, or integration by an arbitrary combination of, addition or omission of a bus to or from hardware in, the outputting server 2 and so forth may be suitably performed.

[6] Others

While a preferred embodiment of the present disclosure has been described above in detail, the present technology is not limited to the specific embodiment, and variations and modifications can be made without departing from the scope of the present invention.

For example, the functional blocks of the outputting server 2 depicted in FIGS. 6 and 27 may be merged in an arbitrary combination or may be divided.

Further, the outputting server 2 according to the embodiment may output the first integration list 22c by the first integration unit 27 in order to provide the list 22c to a user. Similarly, the outputting server 2 according to the first or second modification may output the operation data list 22a or the operation decision list 22b complemented by the complementation process unit 26 in order to provide the list 22a or 22b to a user.

While it is described in the description of the embodiment and the first and second modifications that the operation actual results report 21b is provided on a Web site in the Web server 4, the providing method of the operation actual results report 21b to a user is not limited to that described above. For example, the outputting server 2 may acquire a mail address of a user as the VM management information 31a and describe the substance of the operation actual results report 21b in a mail and then transmit the resulting mail to the user. Further, with regard to a virtual machine VM11 that has been in an idle state for a long period of time (for example, has continuously been in an idle state for 7 days or more or for a predetermined number of hours or more), the outputting server 2 may issue a notification reporting operation actual results to the user by a popup or the like at a timing at which the user executes power ON control or power OFF control of the virtual machine VM11.

Further, it is described in the foregoing description that a result of totalization of operation data 19a is presented to a user, in the embodiment, after every month and, in the first and second modifications, after every one hour. However, the presentation is not limited to this. As a timing at which a report of operation actual results is to be provided, a timing immediately after the outputting server 2 executes decision of an operation state may be applied. For example, since the operation data 19a acquired by the operating information collecting unit 18 of the management virtual machine VM15 is updated in a unit of 10 minutes, the outputting server 2 may sample the operation data 19a updated after every one day or after every one hour (or after every several hours) and execute decision of an operation state and then issue a notification to a user at a stage at which a result of the decision is obtained. Consequently, the operation actual results report 21b that includes a result of the decision prior by one day or by one hour (or by several hours) and is nearer to the state at present can be provided to a user.

Further, while it is described in the description of the embodiment that the range (period) in which totalization of the operation actual results report 21b is performed is one month, an operation situation may be provided not on the basis of monthly totalization but after a period of one week or one day in accordance with a request of a user or the like. At this time, the functions of the first integration unit 27 and the second integration unit 28 may be suitably combined or omitted on the basis of the first and second modifications described above.

With the embodiment, operation actual results obtained by complementing operating information of a virtual machine within a period within which operating information is not acquired can be outputted.

All examples and conditional language recited herein are intended for the pedagogical purposes of aiding the reader in understanding the invention and the concepts contributed by the inventor to further the art, and are not to be construed limitations to such specifically recited examples and conditions, nor does the organization of such examples in the specification relate to a showing of the superiority and inferiority of the invention. Although one or more embodiments of the present inventions have been described in detail, it should be understood that the various changes, substitutions, and alterations could be made hereto without departing from the spirit and scope of the invention.

What is claimed is:

1. A computer-readable recording medium having stored therein an outputting program for causing a computer to execute a process, the process comprising:
acquiring operating information relating to an operation situation within a predetermined period of a virtual machine operating on an information processing apparatus from a management machine that performs acquisition of the operating information and activation control of the virtual machine; and
outputting, where a first period within which operating information of the virtual machine is not acquired is included in the predetermined period, operation actual results of the virtual machine within the first period based on operating information of the management machine within the first period and operating information of the virtual machine acquired at least at one of preceding and succeeding timings to the first period.

2. The computer-readable recording medium having stored therein the outputting program according to claim 1, wherein the process further comprises estimating, where a second period within which operating information of the management machine is not acquired is included in the first period, an operation state of the virtual machine within a period not included in the second period from within the first period as a stopping state.

3. The computer-readable recording medium having stored therein the outputting program according to claim 1, wherein the process further comprises estimating an operation state of the virtual machine in the second period within which operating information of the management machine is not acquired based on the operating information of the virtual machine acquired at least at one of preceding and succeeding timings to the second period.

4. The computer-readable recording medium having stored therein the outputting program according to claim 3, wherein the process further comprises deciding, where it is estimated that the operation state of the virtual machine in the second period is an active state, the operation state of the virtual machine in the second period from one of a processing execution state and an idle state based on the operating information of the virtual machine acquired at least at one of the preceding and succeeding timings to the second period.

5. The computer-readable recording medium having stored therein the outputting program according to claim 4, wherein the process further comprises deciding the operation state of the virtual machine from one of the processing execution state and the idle state based on a time period within which the operating information of the virtual machine acquired at least at one of the preceding and succeeding timings to the second period is lower than a threshold value.

6. The computer-readable recording medium having stored therein the outputting program according to claim 1, wherein the process further comprises:
deciding an operation state of the virtual machine within at least one of preceding and succeeding periods to the first period from within the predetermined period based on operating information of the virtual machine acquired at least atone of preceding and succeeding timings to the first period;
estimating, based on the decided operation state and the estimated operation state of the virtual machine within the first period, an operation state of the virtual machine within the predetermined period; and
outputting the estimated operation state in a state included in operation actual results of the virtual machine within the predetermined period including the first period.

7. An output apparatus, comprising:
a processor configured to:
acquire operating information relating to an operation situation within a predetermined period of a virtual machine operating on an information processing apparatus from a management machine that performs acquisition of the operating information and activation control of the virtual machine;
estimate, where a first period within which operating information of the virtual machine is not acquired is included in the predetermined period, operation actual results of the virtual machine within the first period based on operating information of the management machine within the first period and operating information of the virtual machine acquired at least at one of preceding and succeeding timings to the first period; and
output the estimated operation actual results of the virtual machine in the first period.

8. The output apparatus according to claim 7, wherein, where a second period within which operating information of the management machine is not acquired is included in the first period, the processor estimates an operation state of the virtual machine within a period not included in the second period from within the first period as a stopping state.

9. The output apparatus according to claim 7, wherein the processor estimates an operation state of the virtual machine in the second period within which operating information of the management machine is not acquired based on the operating information of the virtual machine acquired at least atone of preceding and succeeding timings to the second period.

10. The output apparatus according to claim 9, wherein, where it is estimated that the operation state of the virtual machine in the second period is an active state, the processor decides the operation state of the virtual machine in the second period from one of a processing execution state and an idle state based on the operation state of the virtual machine acquired at least at one of preceding and succeeding timings to the second period.

11. The output apparatus according to claim 10, wherein the processor decides the operation state of the virtual machine from one of the processing execution state and the idle state based on a time period within which the operating information of the virtual machine acquired at least at one of preceding and succeeding timings to the second period is lower than a threshold value.

12. The output apparatus according to claim 7, wherein the processor:
decides an operation state of the virtual machine within at least one of preceding and succeeding periods to the first period from within the predetermined period based on operating information of the virtual machine acquired at least atone of preceding and succeeding timings to the first period;
estimates, based on the decided operation state and the estimated operation state of the virtual machine within the first period, an operation state of the virtual machine within the predetermined period; and
outputs the estimated operation state in a state included in operation actual results of the virtual machine within the predetermined period including the first period.

13. An outputting method, comprising:
acquiring operating information relating to an operation situation within a predetermined period of a virtual machine operating on an information processing apparatus from a management machine that performs acquisition of the operating information and activation control of the virtual machine; and
outputting, where a first period within which operating information of the virtual machine is not acquired is included within the predetermined period, operation actual results of the virtual machine within the first period based on operating information of the management machine within the first period and operating information of the virtual machine acquired at least at one of preceding and succeeding timings to the first period.

14. The outputting method according to claim 13, further comprising estimating, where a second period within which operating information of the management machine is not acquired is included in the first period, an operation state of the virtual machine within a period not included in the second period from within the first period as a stopping state.

15. The outputting method according to claim 13, further comprising estimating an operation state of the virtual machine in the second period within which operating information of the management machine is not acquired based on the operating information of the virtual machine acquired at least atone of preceding and succeeding timings to the second period.

16. The outputting method according to claim 15, further comprising deciding, where it is estimated that the operation state of the virtual machine in the second period is an active state, the operation state of the virtual machine in the second period from one of a processing execution state and an idle state based on the operation state of the virtual machine acquired at least at one of preceding and succeeding timings to the second period.

17. The outputting method according to claim 16, further comprising deciding the operation state of the virtual machine from one of the processing execution state and the idle state based on a time period within which the operating information of the virtual machine acquired at least at one of preceding and succeeding timings to the second period is lower than a threshold value.

18. The outputting method according to claim 13, further comprising:
deciding an operation state of the virtual machine within at least one of preceding and succeeding periods to the first period from within the predetermined period based on operating information of the virtual machine acquired at least atone of preceding and succeeding timings to the first period;
estimating, based on the decided operation state and the estimated operation state of the virtual machine within the first period, an operation state of the virtual machine within the predetermined period; and
outputting the estimated operation state in a state included in operation actual results of the virtual machine within the predetermined period including the first period.
